(19) United States
(12) Patent Application Publication
(10) Pub. No.: US 2009/0077118 A1
(43) Pub. Date: Mar. 19, 2009

(54) INFORMATION CARD FEDERATION POINT TRACKING AND MANAGEMENT

(75) Inventors: Thomas E. Doman, Pleasant Grove, UT (US); Wendy Michelle Busath, Springville, UT (US); Duane F. Buss, West Mountain, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/323,177

(22) Filed: Nov. 25, 2008

Related U.S. Application Data
(63) Continuation-in-part of application No. 11/830,492, filed on Jul. 30, 2007.
Application No. 11/830,492 is a continuation-in-part of application No. 11/843,591, filed on Aug. 22, 2007.
Application No. 11/843,591 is a continuation-in-part of application No. 12/054,774, filed on Mar. 25, 2008.
Application No. 12/054,774 is a continuation-in-part of application No. 12/044,816, filed on Mar. 7, 2008.
Application No. 11/843,591 is a continuation-in-part of application No. 11/843,572, filed on Aug. 22, 2007.
Application No. 11/843,572 is a continuation-in-part of application No. 11/843,638, filed on Aug. 22, 2007.
Application No. 11/843,638 is a continuation-in-part of application No. 11/843,640, filed on Aug. 22, 2007.
(60) Provisional application No. 60/895,312, filed on Mar. 16, 2007.
(60) Provisional application No. 60/895,312, filed on Mar. 16, 2007.
(60) Provisional application No. 60/895,312, filed on Mar. 16, 2007.
(60) Provisional application No. 60/895,316, filed on Mar. 16, 2007.
(60) Provisional application No. 60/895,316, filed on Mar. 16, 2007.
(60) Provisional application No. 60/895,316, filed on Mar. 16, 2007.
(60) Provisional application No. 60/895,325, filed on Mar. 16, 2007.
(60) Provisional application No. 60/895,325, filed on Mar. 16, 2007.
(60) Provisional application No. 60/895,325, filed on Mar. 16, 2007.

(51) Int. Cl. G06F 17/30; G06F 17/00

(52) U.S. Cl. 707/102; 707/100; 707/201; 707/E17.005

(57) ABSTRACT

A client can store information about federation points. A federation point is a combination of an identifier of an account on a relying party and an identifier of an information card. The client can track which information cards are included n various federation points, and can use this information to assist the user in performing a transaction with relying parties.

### RELATED APPLICATION DATA

This application is a continuation-in-part of co-pending U.S. patent application Ser. No. 11/830,492, titled “SYSTEM AND METHOD FOR ORDERED CREDENTIAL SELECTION”, filed Jul. 30, 2007, of co-pending U.S. patent application Ser. No. 12/054,774, titled “CLAIM CATEGORY HANDLING”, filed Mar. 25, 2008, of co-pending U.S. patent application Ser. No. 11/843,591, titled “CREDENTIAL CATEGORIZATION”, filed Aug. 22, 2007, of co-pending U.S. patent application Ser. No. 12/054,774, titled “CLAIM CATEGORY HANDLING”, filed Mar. 25, 2008, and of co-pending U.S. patent application Ser. No. 12/044,816, titled “SYSTEM AND METHOD FOR USING WORKFLOWS WITH INFORMATION CARDS”, filed Mar. 7, 2008, all of which are hereby incorporated by reference for all purposes. Co-pending U.S. patent application Ser. No. 11/843,591, titled “CREDENTIAL CATEGORIZATION”, filed Aug. 22, 2007, is a continuation in part of co-pending U.S. patent application Ser. No. 11/843,572, “PERFORMING A BUSINESS TRANSACTION WITHOUT DISCLOSING SENSITIVE IDENTITY INFORMATION TO A RELYING PARTY” filed Aug. 22, 2007, of co-pending U.S. patent application Ser. No. 11/843,638, titled “POLICY-BASED AUDITING OF IDENTITY CREDENTIAL DISCLOSURE BY A SECURE TOKEN SERVICE”, filed Aug. 22, 2007 and of co-pending U.S. patent application Ser. No. 11/843,640, titled “FRAMEWORK AND TECHNOLOGY TO ENABLE THE PORTABILITY OF INFORMATION CARDS”, filed Aug. 22, 2007, all of which are hereby incorporated by reference for all purposes. Co-pending U.S. patent application Ser. No. 11/843,572, titled “PERFORMING A BUSINESS TRANSACTION WITHOUT DISCLOSING SENSITIVE IDENTITY INFORMATION TO A RELYING PARTY”, filed Aug. 22, 2007, co-pending U.S. patent application Ser. No. 11/843,638, titled “POLICY-BASED AUDITING OF IDENTITY CREDENTIAL DISCLOSURE BY A SECURE TOKEN SERVICE”, filed Aug. 22, 2007, and co-pending U.S. patent application Ser. No. 11/843,640, titled “FRAMEWORK AND TECHNOLOGY TO ENABLE THE PORTABILITY OF INFORMATION CARDS”, filed Aug. 22, 2007, all claim the benefit of U.S. Provisional Patent Application Ser. No. 60/895,312, filed Mar. 16, 2007, U.S. Provisional Patent Application Ser. No. 60/895,316, filed Mar. 16, 2007, and U.S. Provisional Patent Application Ser. No. 60/895,325, filed Mar. 16, 2007, all of which are herein incorporated by reference for all purposes.

This application is also related to co-pending U.S. patent application Ser. No. 11/768,755, titled “TIME-BASED METHOD FOR AUTHORIZING ACCESS TO RESOURCES”, filed Jun. 26, 2007, to co-pending U.S. patent application Ser. No. 11/843,608, titled “CHAINING INFORMATION CARD SELECTORS”, filed Aug. 22, 2007, to co-pending U.S. patent application Ser. No. 12/019,104, titled “PROCESSING HTML EXTENSIONS TO ENABLE SUPPORT OF INFORMATION CARDS BY A RELYING PARTY”, filed Jan. 24, 2008, to co-pending U.S. patent application Ser. No. 12/026,775, titled “METHODS FOR SETTING AND CHANGING THE USER CREDENTIAL IN INFORMATION CARDS”, filed Feb. 6, 2008, to co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, to co-pending U.S. patent application Ser. No. 12/030,063, titled “INFO CARD SELECTOR RECEPTION OF IDENTITY PROVIDER BASED DATA PERTAINING TO INFO CARDS”, filed Feb. 12, 2008, to co-pending U.S. patent application Ser. No. 12/038,674, titled “SYSTEM AND METHOD FOR SECURE ACCOUNT RESET UTILIZING INFORMATION CARDS”, filed Feb. 27, 2008, to co-pending U.S. patent application Ser. No. 12/042,205, titled “PRIVATELY SHARING RELYING PARTY REPUTATION WITH INFORMATION CARD SELECTORS”, filed Mar. 4, 2008, to co-pending U.S. patent application Ser. No. 12/054,137, titled “CARDSPACE HISTORY VALIDATOR”, filed Mar. 24, 2008, to co-pending U.S. patent application Ser. No. 12/108,805, titled “RESTRICTED USE INFORMATION CARDS”, filed Apr. 24, 2008, to co-pending U.S. patent application Ser. No. 12/111,874, titled “REMOTABLE INFORMATION CARDS”, filed Apr. 29, 2008, to co-pending U.S. patent application Ser. No. 12/112,772, titled “DYNAMIC INFORMATION CARD RENDERING”, filed Apr. 30, 2008, to co-pending U.S. patent application Ser. No. 12/170,834, titled “NON-INTERACTIVE INFORMATION CARD TOKEN GENERATION”, filed Jul. 9, 2008, to co-pending U.S. patent application Ser. No. 12/184,155, titled “SITE-SPECIFIC CREDENTIAL GENERATION USING INFORMATION CARDS”, filed Jul. 31, 2008, to co-pending U.S. patent application Ser. No. 12/201,754, titled “SYSTEM AND METHOD FOR VIRTUAL INFORMATION CARDS”, filed Aug. 29, 2008, to co-pending U.S. patent application Ser. No. 12/243,619, titled “SYSTEM AND METHOD FOR APPLICATION-INTEGRATED INFORMATION CARD SELECTION”, filed Oct. 1, 2008, to co-pending U.S. patent application Ser. No. 12/248,815, titled “TRUSTED RELYING PARTY PROXY FOR INFORMATION CARD TOKENS”, filed Oct. 9, 2008, to co-pending U.S. patent application Ser. No. 12/253,860, titled “SMART CARD BASED ENCRYPTION KEY AND PASSWORD GENERATION AND MANAGEMENT”, filed Aug. 29, 2008, and to co-pending U.S. patent application Ser. No. ______, titled “INFORMATION CARD FEDERATION POINT TRACKING AND MANAGEMENT”, filed herewith, all of which are herein incorporated by reference for all purposes.

### FIELD OF THE INVENTION

This invention pertains to using information cards, and more particularly to tracking and managing federation points and the information cards used to access the federation points.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal to the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) Second, the user has no control over how the service provider uses the information it stores. If the service provider uses the stored information in a way the user does not want, the user has relatively little ability to prevent such abuse, or recourse after the fact.

To address this problem, new systems have been developed that allow the user a measure of control over the information stored about the user. Windows CardSpace™ (sometimes called CardSpace) is a Microsoft implementation of an identity meta-system that offers a solution to this problem. (Microsoft, Windows, and CardSpace are either registered trademarks or trademarks of Microsoft Corporation in the United States and/or other countries.) A user can store identity information with an identity provider the user trusts. When a service provider wants some information about the user, the user can control the release of information stored with the identity provider to the service provider. The user can then use the offered services that required the identity information.

While this system simplifies the management of information used to satisfy the requests of service providers, there are potential problems. A single user might have more than one account on a given service provider's computer system. For example, the user might have a basic account that gives the user a typical level of access, and an administrator account that gives the user a greater level of control. In addition, some service providers offer different privileges to an account based on how satisfied the service provider is with the identity of the user (that is, based on what claims are included in the security token). In these situations, the user has to remember which information card was provided to the service provider to gain access to the desired accounts. This problem is a serious inconvenience when the user is dealing with only one service provider: when the user has to deal with dozens or hundreds of service providers, each demanding different information to gain access to the desired accounts, remembering what information should be provided to gain access to a particular service becomes effectively impossible.

A need remains for a way to addresses these and other problems associated with the prior art.

### SUMMARY OF THE INVENTION

In an embodiment of the invention, a user of a client can engage in a transaction with a relying party. The client can store information about federation points locally, or the information about federation points can be contextually generated as needed. A card selector on the client can present to the user information about the federation points, to assist the user in selecting an information card that will give the user access to the desired account on the relying party.

In another embodiment of the invention, the user of a client can request to manage federation points and information cards. An identifier can identify federation points and information cards to which the user's request is applicable, enabling the user to manage the federation points and information cards.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIGS. 2A-2B show the client of FIG. 1 equipped to provide information to a user about federation points and information cards, both to carry out a transaction with a relying party and to manage the information about the federation points and information cards, according to a first embodiment of the invention.

FIG. 3 shows the identity provider of FIG. 1 including a secure token generator.

FIG. 4 shows the client of FIGS. 2A-2B including a secure token generator.

FIG. 5 shows details about federation points on the clients of FIGS. 2A-2B.

FIG. 6 shows details about accounts on the relying party of FIG. 1, along with levels of access associated with each account, according to a second embodiment of the invention.

FIG. 7 shows types of requests a user can make in managing federation points and information cards on the client of FIGS. 2A-2B.

FIG. 8 shows the relying party of FIG. 1 with an endpoint to process requests for information from the endpoint.

FIG. 9 shows the client of FIGS. 2A-2B and another client synchronizing federation point information and information cards.

FIG. 10 shows the details about the federation point merger of FIG. 2B.

FIG. 11 shows details about the information card merger of FIG. 2B.

FIGS. 12A-12E show a flowchart of a procedure for the client of FIGS. 2A-2B to perform a transaction with a relying party using federation point information.

FIG. 13 shows a flowchart of a procedure for the client of FIGS. 2A-2B to query an endpoint on the relying party for information about an account on the relying party.

FIGS. 14A-14B show a flowchart of a procedure for the client of FIGS. 2A-2B to manage federation points and information cards.

FIG. 15 shows a flowchart of a procedure for the relying party of FIG. 1 to respond to a query for information about an account on the relying party.

FIG. 16 shows a flowchart of a procedure for the relying party to use information derived from an information card to respond to a query for information about an account on the relying party.

FIG. 17 shows a flowchart of a procedure for the client of FIGS. 2A-2B to export information about federation points and/or information cards to another client, as part of a synchronization process.

FIG. 18 shows a flowchart of a procedure for the client of FIGS. 2A-2B to import information about federation points and/or information cards from another client, as part of a synchronization process.

FIG. 19 shows a flowchart of a procedure for the client of FIGS. 2A-2B to synchronize information about federation points imported from another client.

FIG. 20 shows a flowchart of a procedure for the client of FIGS. 2A-2B to synchronize information about information cards imported from another client.

### DETAILED DESCRIPTION OF THE PREFERRED EMBODIMENT

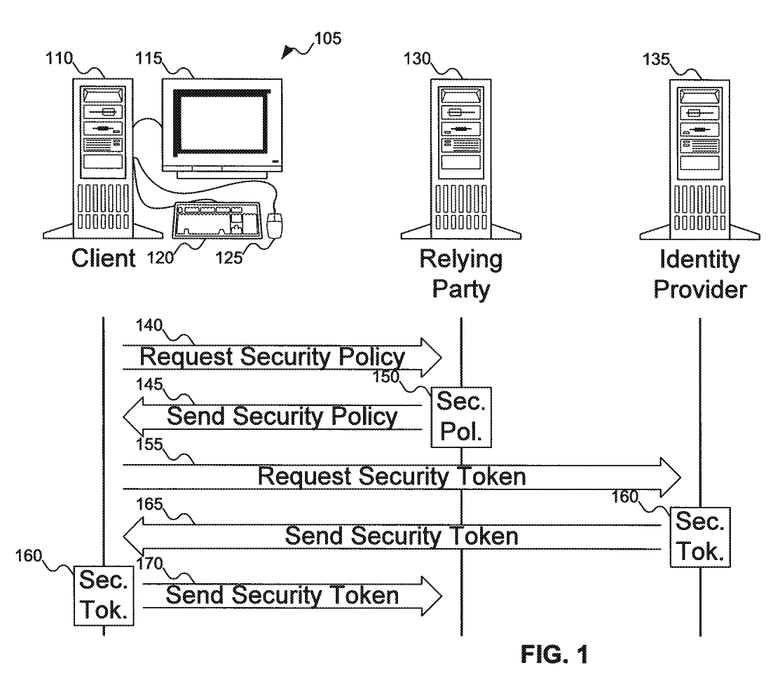

Before explaining the invention, it is important to understand the context of the invention. FIG. 1 shows a sequence of communications between a client, a relying party, and an identity provider. For simplicity, each party (the client, the relying party, and the identity provider) can be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of computer system 105: for example, a central processing unit, memory, storage, etc. Although not shown in FIG. 1, a person skilled in the art will recognize that computer system 105 can interact with other computer systems, such as relying party 130 and identity provider 135, either directly or over a network (not shown in FIG. 1) of any type. Finally, although FIG. 1 shows computer system 105 as a conventional desktop computer, a person skilled in the art will recognize that computer system 105 can be any type of machine or computing device capable of providing the services attributed herein to computer system 105, including, for example, a laptop computer, a personal digital assistant (PDA), or a cellular telephone.

Relying party 130 is a machine managed by a party that relies in some way on the identity of the user of computer system 105. The operator of relying party 130 can be any type of relying party. For example, the operator of relying party 130 can be a merchant running a business on a website. Or, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party. Depending on the type of information identity provider 135 stores for a user, a single user might store identifying information with a number of different identity providers 135, any of which might be able to satisfy the request of the relying party. For example, identity provider 135 might be a governmental agency, responsible for storing information generated by the government, such as a driver's license number or a social security number. Or, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, computer system 105 requests the security policy of relying party 130, as shown in communication 140, which is returned in communication 145 as security policy 150. Security policy 150 is a summary of the information relying party 130 needs, how the information should be formatted, and so on.

Once computer system 105 has security policy 150, computer system 105 can identify which information cards will satisfy security policy 150. Different security policies might result in different information cards being usable. For example, if relying party 130 simply needs a user's e-mail address, the information cards that will satisfy this security policy might be different from the information cards that satisfy a security policy requesting the user's full name, mailing address, and social security number. The user can then select an information card that satisfies security policy 150.

Once the user has selected an acceptable information card, computer system 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Computer system 105 then forwards security token 160 to relying party 130, as shown in communication 170.

In addition, the selected information card can be a self-issued information card: that is, an information card issued not by an identity provider, but by computer system 105 itself. In that case, identity provider 135 effectively becomes part of computer system 105.

In this model, a person skilled in the art will recognize that because all information flows through computer system 105, the user has a measure of control over the release of the user's identity information. Relying party 130 only receives the information the user wants relying party 130 to have, and does not store that information on behalf of the user (although it would be possible for relying party 130 to store the information in security token 160: there is no effective way to prevent such an act).

The problem with this model is, as noted above, that the user is responsible for managing the selection of the information card to be used in generating the security token. A typical user can have a large number of information cards, any of which might be used to satisfy the security policy of relying party 130. A subset of the user's information cards might be “interchangeable” in the sense that any could be used to generate an acceptable security token. But depending on which information card is used to generate the security token, the user might be granted access to different accounts. For example, if relying party 130 were to use the e-mail address from the security token to identify which account to give the user access to, then it might matter which information card the user selected to generate security token 160. Using an information card including a different e-mail address might result in the user not receiving access to the desired account, or even potentially denying the user access to any account on relying party 130. (A person skilled in the art will recognize that relying party 130 can use potentially any information in the security token to determine what level of services to give the user, and not just the user's e-mail address.)

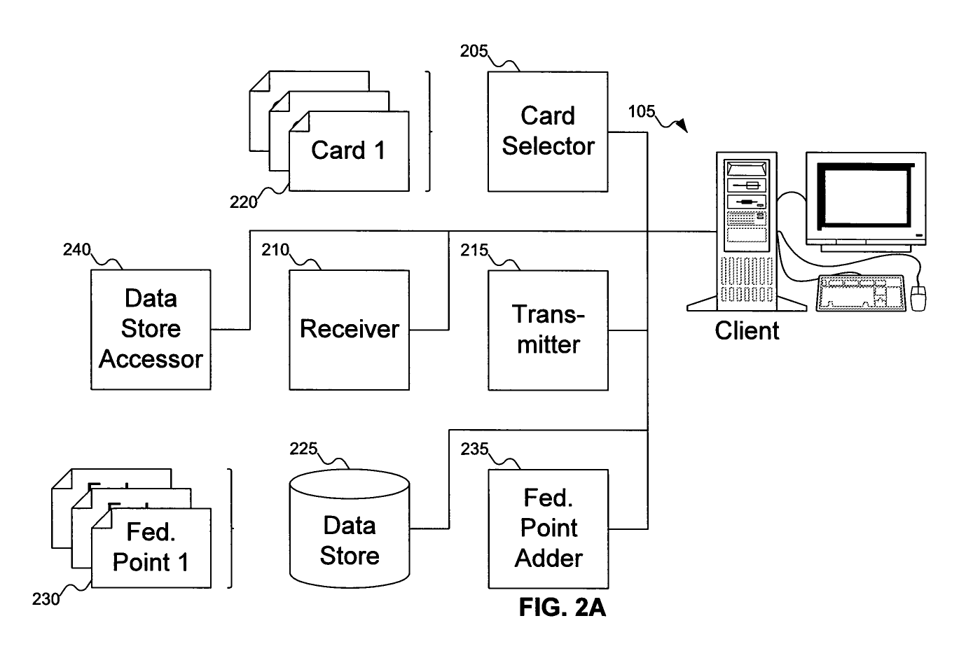

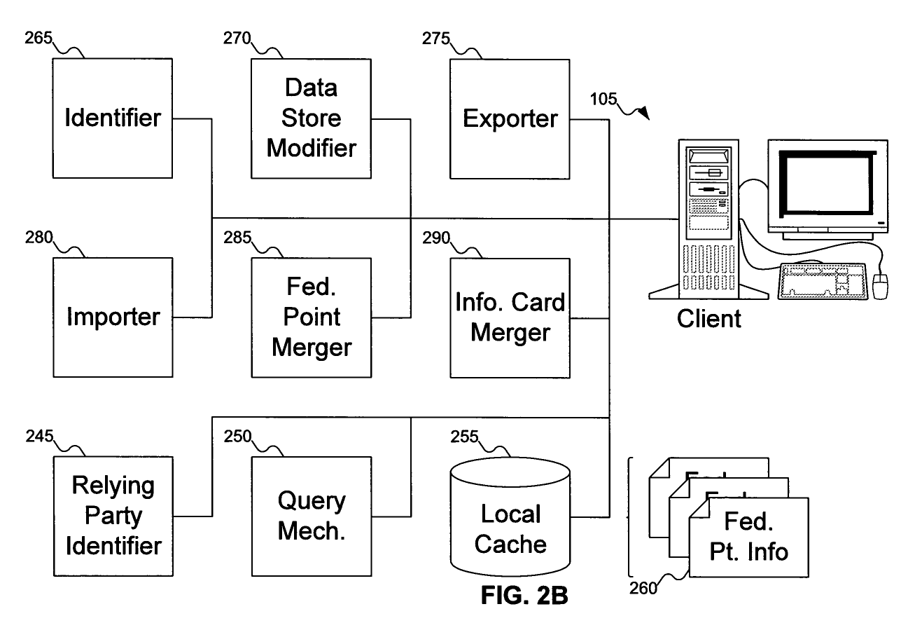

Now that the problem—managing which information cards provide access to which accounts/services on various relying parties—is understood, embodiments of the invention can be explained. In FIGS. 2A-2B, details about client 105 are shown. A person skilled in the art will recognize that FIGS. 2A-2B show different components that can be included in client 105. A person skilled in the art will also recognize that it is not required that client 105 include every component of FIGS. 2A-2B in every embodiment, as different components are applicable to different embodiments of the invention. A person skilled in the art will also recognize that FIGS. 2A-2B do not represent specific potential embodiments of the invention: potential embodiments of the invention can include features from each of FIGS. 2A-2B, as appropriate to the embodiment of the invention.

In FIG. 2A, computer system 105 is shown as including card selector 205, receiver 210, and transmitter 215. Card selector 205 enables the user of the client to select information card 220 to use in a particular transaction. Receiver 210 receives data transmitted to computer system 105, and transmitter 215 transmits information from computer system 105.

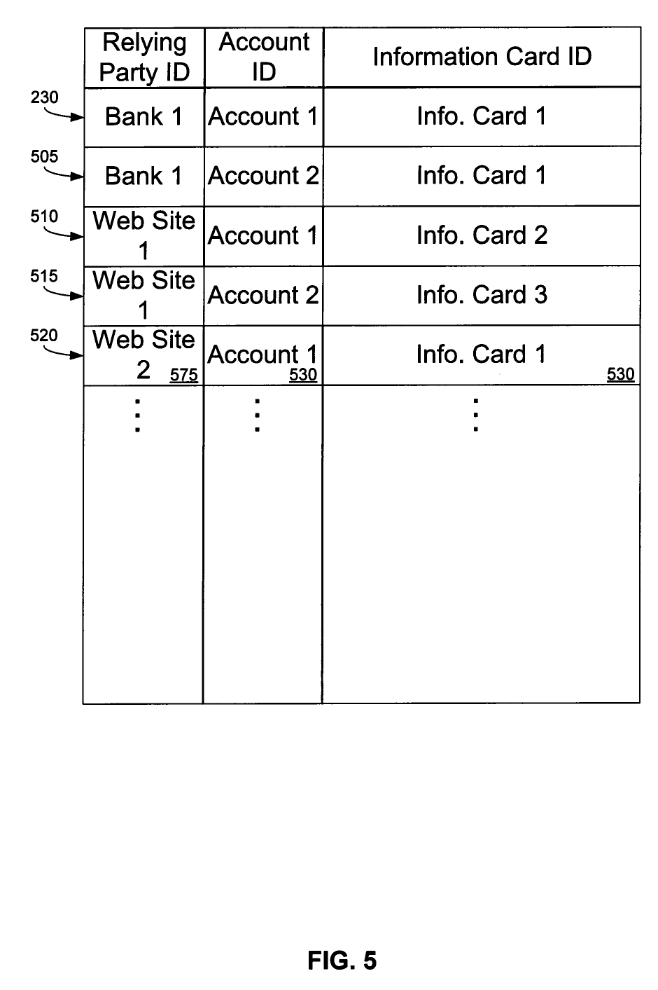

In addition to these components, computer system 105 includes data store 225, which stores information about federation points, such as federation point 230. A federation point is a combination of an identifier of an information card and an identifier of an account on the relying party; federation points are discussed further with reference to FIG. 5 below. (A person skilled in the art will recognize that, to identify an account on a relying party, the relying party can also be identified as part of the federation point.) Note that the concept of a federation point can be used by the client; the relying party is generally concerned with the security token it ultimately receives, and generally does not care about which information card the client used to generate the security token. But as the security token can include the private personal identifier (PPID) of the information card used to generate the security token, the relying party can also be aware of an identifier of the information card used to generate the security token. There can be other ways to identify a security token: for example, the identity provider can include some information that remains constant across multiple requests for a security token (provided that the claims to be included in the security token do not change).

Computer system 105 also includes federation point adder 235 and data store accessor 240. Federation point adder 235 enables a user to define a new federation point. While federation point adder 235 can provide an interface for a user to manually specify an account on a relying party and an information card on client 105, a person skilled in the art will recognize that federation point adder 235 can operate in other ways. For example, when card selector 205 receives a user's selection of information card 220 to satisfy a request for a security token from a relying party, assuming no federation point exists that represents the combination, federation point adder 235 can prompt the user as to whether this combination represents a new federation point. Upon receiving the user's confirmation, federation point adder 235 can add the combination as a new federation point in data store 225. Data store accessor 240 enables computer system 105 to retrieve information about federation points from data store 225. Data store accessor 240 operates in a manner consistent with any other technique to access data from a data store.

Although FIG. 2A shows client 105 as storing federation point 230 separately from information card 220 (in FIG. 2A, specifically in data store 225), a person skilled in the art will recognize that federation point 230 can be stored in other ways. For example, federation point 230 can be stored as metadata in information card 220. A person skilled in the art will recognize how embodiments of the invention can be modified to support accessing federation point 230 from metadata stored in information card 220.

Turning to FIG. 2B, computer system 105 can also include relying party identifier 245. Relying party identifier 245 identifies the relying party that has requested a security token. This enables computer system 105 to be able to identify federation points that include the identified relying party (and also which information cards on computer system 105 are included in those federation points).

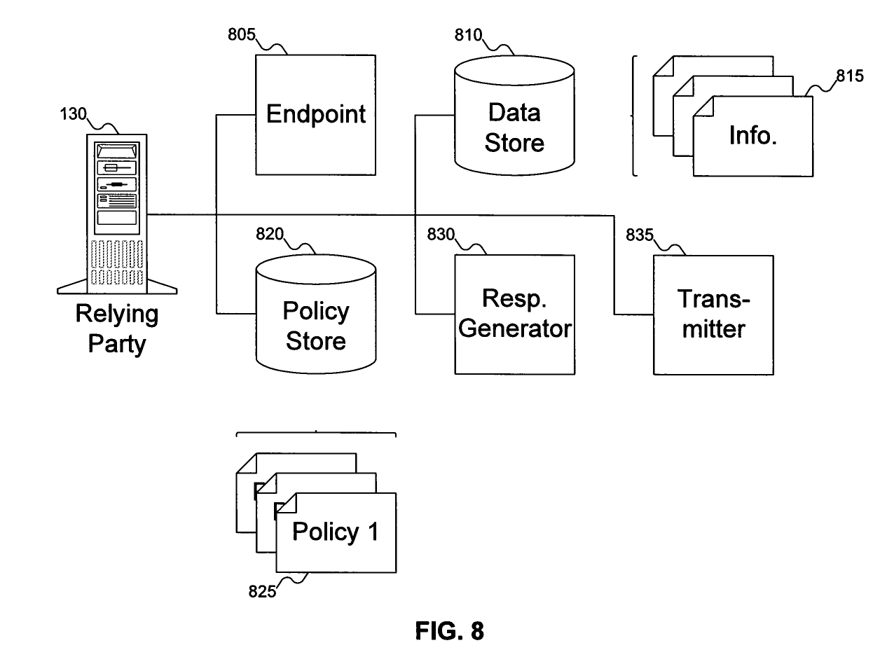

Computer system 105 also includes query mechanism 250. Query mechanism 250 can send a query to an endpoint on a relying party. This query can find out information about how the relying party processes security tokens, among other possibilities. For example, query mechanism 250 can query the endpoint on the relying party for how the relying party handled a security token the last time it was sent (that is, the relying party can indicate to which account the user was granted access after providing the security token). This query can be performed by submitting a security token to the relying party endpoint, or by uniquely identifying the security token in some way (but without providing the actual security token). Query mechanism 250 can also query the endpoint for how it might handle a hypothetical security token, if issued in response to a security policy: for example, an account to which the user might be granted access if the hypothetical security token were provided to the relying party. Query mechanism 250 can also query the relying party endpoint for information about the account to which the user currently has access (assuming there is an active session between client 105 and the relying party). Query mechanism 250 can also query the relying party endpoint about what claims the user could include in a security token and the accounts to which the relying party would grant the user access based on those claims. The endpoint on the relying party is discussed below with reference to FIG. 8.

Computer system 105 can include local cache 255, which can store information 260 about federation points, received from the endpoint on the relying party, in response to queries. Storing information 260 about federation points enables client 105 to use information 260 again, without having to query the end point of the relying party again. But a person skilled in the art will recognize that local cache 255 can be omitted without reducing the functionality of embodiments of the invention.

FIG. 2B also shows computer system 105 is shown as including identifier 265 and data store modifier 270. Identifier 265 can identify federation points and information cards on computer system 105 that the user is potentially interested in modifying. More particularly, if a user issues a request to modify a federation point or an information card, identifier 265 can identify which federation points and information cards might be covered by the request, so that the user can be shown those federation points and information cards. Then, when the user indicates the desired modification, data store modifier 270 can modify the data store accordingly. This modification can include adding, deleting, or modifying federation points, or adding, deleting, or modifying information cards. (A person skilled in the art will recognize that “modifying” an existing item, such as a federation point or an information card, can be thought of as equivalent to deleting an existing item and adding a new item.)

Computer system 105 can also include exporter 275, importer 280, federation point merger 285, and information card merger 290. Exporter 275 exports federation point information from computer system 105. (A person skilled in the art will recognize that “federation point information” is not limited to just the combinations of accounts on relying parties and information cards. For example, modifications to information cards can have an impact on federation points as well, and so “federation point information” can include the information cards as well.) For example, the user might have both a work computer and a personal (home) computer, and might want to be able to use the federation point information on both machines. If the federation point information were available on only one of these machines, then the user would be unable to take advantage of embodiments on the invention on the other machine. By synchronizing the two machines, the user would be able to use embodiments of the invention from both machines. Exporting federation point information using exporter 275 enables such synchronization. (A person skilled in the art will recognize that embodiments of the invention do not limit the user to being able to use federation point information on just two machines: federation point information can be synchronized to any number of devices, including, among other possibilities, notebook or laptop computers, cellular telephones, and personal digital assistants (PDA).)

Corresponding to exporter 275 is importer 280, which imports information exported from another machine. Although FIG. 2B shows exporter 275 and importer 280 on the same machine, as will often be the case (as a machine capable of exporting information for synchronization on another machine is typically capable of receiving information for synchronization from another machine), typically the client that performs the export of federation point information and the client that performs import of federation point information are different machines. Once computer system 105 has imported the federation point information, federation point merger 285 can merge the imported information about federation points into the client, and information card merger 290 can merge the imported information about information cards into the client.

Not shown in FIGS. 2A-2B are features combining embodiments of the invention with features of related patent applications. Co-pending U.S. patent application Ser. No. 12/044,816, titled “SYSTEM AND METHOD FOR USING WORKFLOWS WITH INFORMATION CARDS”, filed Mar. 7, 2008, which is hereby incorporated by reference for all purposes, describes workflows and cardflows. In some embodiments of the invention, a background, periodic maintenance mechanism can keep federation point information in the information cards in the card store up to date. Cardflows can be defined for all or a subset of the information cards in a given card store. These cardflows can be configured to invoke the relying party endpoint as described below at a specified time and for a specified set of relying parties to update federation point information.

Co-pending U.S. patent application Ser. No. 12/054,774, titled “CLAIM CATEGORY HANDLING”, filed Mar. 25, 2008, which is hereby incorporated by reference for all purposes, describes how security policies can specify that claims to be included in the security token can be categorized other than simply “required” or “optional. In some embodiments of the invention, claim categories can be used to sort, locate, and present information cards to the user. Federation point information can also be tied to particular categories of claims in the security token. For example, supplying a particular “desirable” claim can result in the relying party granting the user access to an account including a particular capability (that is, including the “desirable” claim could result in a federation point that is different from a federation point if the “desirable” claim were omitted). Additionally, the claim categories can be used to inform the user about “potential” federation points that could be achieved if the user supplies a claim that is not “required”.

Co-pending U.S. patent application Ser. No. 11/843,991, titled “CREDENTIAL CATEGORIZATION”, filed Aug. 22, 2007, which is herein incorporated by reference for all purposes, can further leverage claim categories by enabling users to define policies indicating which claims are to be included in security tokens. Using such policies can limit the federation points available to the user, but the user might consider that preferable in some circumstances.

Co-pending U.S. patent application Ser. No. 11/830,492, titled “SYSTEM AND METHOD FOR ORDERED CREDENTIAL SELECTION”, filed Jul. 30, 2007, which is hereby incorporated by reference for all purposes, can be used to tag and order the information cards displayed in a card selector. In some embodiments of the invention, the card selector can tag and order information cards according to federation point information.

A person skilled in the art will recognize how the features of these and all other related patent applications can be combined and used in embodiments of the invention.

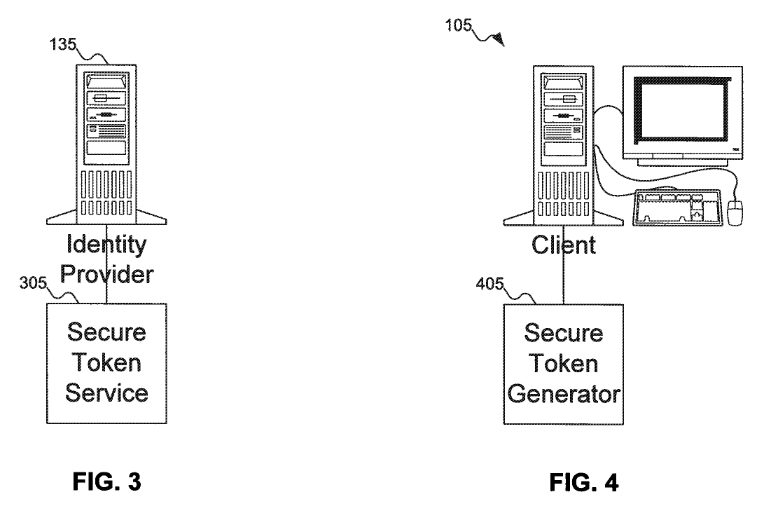

As discussed above with reference to FIG. 1, information cards can be either managed or self-issued. If the information card is managed, then the security token is generated by an identity provider. In FIG. 3, identity provider 135 includes secure token service 305. Secure token service 305 generates the security token as instructed by identity provider 135, responsive to the security policy received from the relying party, and including the claims specified by the client.

If the information card is self-issued (that is, the information card is not managed by an identity provider), then the client generates the security token directly. (The relying party can tell the difference between a security token generated by an identity provider and a security token generated by a client by examining the security token. If the relying party wants to, the relying party can refuse a security token based on a self-issued information card.) In FIG. 4, client 105 includes secure token generator 405, which can generate the security token based on the self-issued information card.

FIG. 5 shows details about federation points on the clients of FIGS. 2A-2B. In contrast to FIG. 2A, where federation points are shown as individual items, FIG. 5 shows the federation points in a table. A person skilled in the art will recognize other ways in which federation point information can be represented. In FIG. 5, information about five federation points is shown, but a person skilled in the art will recognize that there can be any number of federation points stored on the client. Federation points 230 and 505 include a bank account (account 1 with bank 1) and information card 1. Federation point 510 includes account 1 on web site 1 and information card 2. Federation point 515 includes account 2 on web site 1 and information card 3. Finally, federation point 520 includes account 1 on web site 2 and information card 1. (A person skilled in the art will recognize that federation points 230, 505, 510, 515, and 520 do not store the actual relying party, account, or information card, but rather store identifiers of these objects.)

It might be considered curious that FIG. 5 shows two federation points 230 and 505, both including a single information card (information card 1), but associated with different accounts on the relying party (accounts 1 and 2 on bank 1). The reason for this interesting circumstance is that if security tokens provided to the relying party (bank 1) includes different claim sets, the relying party might grant the user access to different accounts, even though the same information card was used to generate the security token. For example, if the bank in federation points 230 and 505 receives a security token including only the user's name and e-mail address, the bank might grant the user access to an account that permits the user view his current balance, but not let the user transfer funds. But if the security token were to also include a biometric, the bank could be more certain that the user is properly authenticated, and might grant the user access to a different account that also permits the user transfer funds from one account to another. If the bank lists the biometric as a desirable claim but does not require it, then the relying party can determine the level of access to grant the user at the time the relying party receives the security token. A person skilled in the art will recognize that this example can be modified so that the same account is used, but the user is granted different levels of privilege associated with the account. (In this situation, there can be multiple federation points associating a single information card with a single account on a relying party.)

The potential for accessing different accounts on the relying party, or even of different levels of access to an individual account on the relying party, based on which claims are included in the security token could be information of value to the user. Continuing the example of the bank in federation points 230 and 505, the user might find it valuable to know that including non-required claims in the security token could give the user access to the different accounts or different levels of access in a single account. (The identification of these non-required claims could be handled as described in co-pending U.S. patent application Ser. No. 12/054,774, titled “CLAIM CATEGORY HANDLING”, filed Mar. 25, 2008, which is hereby incorporated by reference for all purposes.) In one embodiment of the invention (not shown in FIG. 5), the system can store a different federation point to represent these different levels of access. This embodiment of the invention can be achieved by specifying the claims included in the security token in the federation point. For example, federation point 230 can specify that the security token includes only the user's name and e-mail address, and federation point 505 can specify that the security token includes the user's name, e-mail address, and biometric. By storing this additional information, the user can be made aware of the different levels of access granted using the same information card.

FIG. 5 shows that a single information card can be used in multiple federation points. For example, federation points 230 and 520 both include information card 1, using the user's name and e-mail address as claims in the security token. As both account 1 on bank 1 and account 1 on web site 2 request these credentials, the same information card can be used to generate security tokens for both of these accounts. In contrast, federation points 510 and 515 use other information cards: perhaps the user used different e-mail addresses in setting up these accounts, and so different information cards are needed to generate the security token. (A person skilled in the art will recognize other reasons why different information cards might be used for federations 510 and 515: for example, that this relying party will not accept security tokens generated by the identity provider managing information card 1, or this relying party requests a form of encryption not provided by the identity provider managing information card 1.)

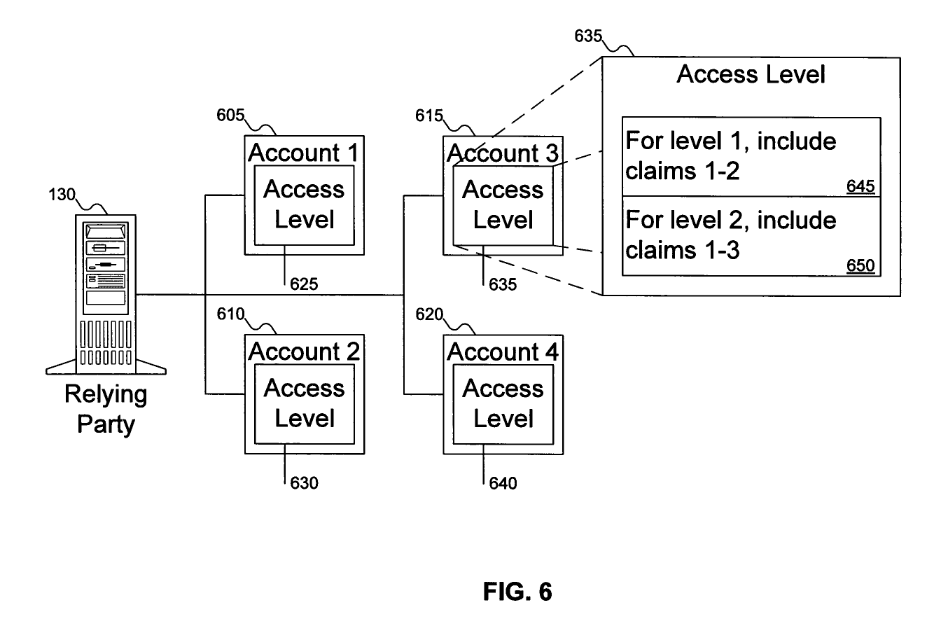

FIG. 6 shows details about accounts on the relying party of FIG. 1, along with levels of access associated with each account, according to a second embodiment of the invention. In FIG. 6, relying party 130 is shown as having four established accounts (605, 610, 615, and 620). For each account, there is a corresponding level of access granted to the user of the account. Thus, for accounts 605, 610, 615, and 620, there are corresponding levels of access 625, 630, 635, and 640.

Level of access 635, for account 615, is enlarged as an example. In FIG. 6, level of access 635 actually includes two different levels of access, depending on which claims are provided in the security token. If the security token satisfies only claims 1-2 (as shown by level of access 645) then the user receives only level 1 access to the account; if the security token satisfies claims 1-3 (as shown by level of access 650), then the user receives level 2 access to the account. Referring back to the example of a bank described above with reference to FIG. 5, level 1 access 645 can be conditioned on receiving only the user's name and e-mail address in the security token; level 2 access 650 can be conditioned on also receiving the user's biometric in the security token.

While level of access 635 shows two levels of access for a single account, a person skilled in the art will recognize that there can be any number of levels of access, conditioned on the claims included in the security token. Further, there can be different rules regarding the levels of access for different accounts offered by relying party 130: not all accounts have to be given the same levels of access. For example, level of access 625 could specify only a single level of access for account 605.

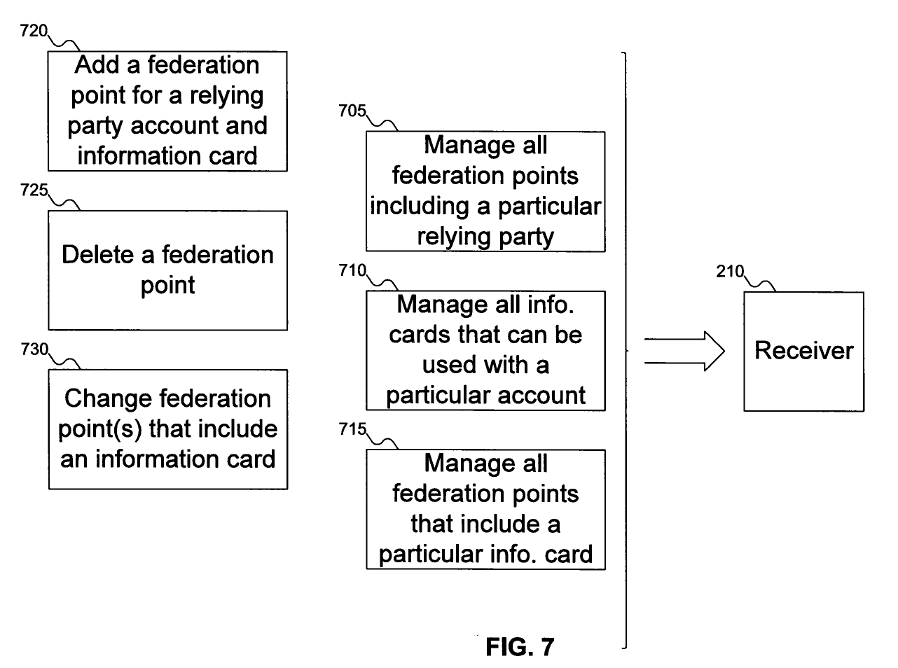

FIG. 7 shows types of requests a user can make in managing federation points and information cards on the client of FIGS. 2A-2B. In FIG. 7, receiver 210 (on the client) can receive any number of different types of requests to manage federation points and information cards. Among the requests the user can make are:
Request 705 to manage all federations points that include a relying party (such management can include adding, deleting, and/or modifying such federation points).
Request 710 to manage all information cards that are included in federation points including a particular account on a particular relying party.
Request 715 to manage all federation points that include a particular information card.
Request 720 to add a federation point for a combination of a relying party account and an information card.
Request 725 to delete a federation point.
Request 730 to change federation point(s) that include a particular information card.

A person skilled in the art will recognize that requests 705, 710, 715, 720, 725, and 730 are merely exemplary types of requests that a user can make in managing federation points and information cards, and that other requests can be made as well. For example, a user can request to add, delete, or modify information cards (without necessarily being limited to those information cards included in a federation point).

As discussed above with reference to FIG. 2B, a client can query an endpoint on a relying party for information about how the relying party might process a particular security token. FIG. 8 shows the relying party of FIG. 1 with an endpoint to process such requests for information from the endpoint. In FIG. 8, relying party 130 includes endpoint 805, which receives the query. Data store 810 stores information that can be used to respond to the query, such as information 815. Such information can include, for example, the last time a security token was received, to which account access was granted based on that security token, and what level of access was granted to that account. While the security token can be represented in data store 810 by storing the security token in its entirety, a person skilled in the art will recognize that there are other ways to represent the security token. For example, the security token can be identified based on an identifier of the information card that was used to generate the security token, a signature modulus used in the security token, and/or an encryption key used to encrypt the security token (or a combination of these components), among other possibilities.

Relying party 130 can also include policy store 820. Policy store 820 stores policies, such as policy 825, that are used to control how relying party 130 responds when it receives a security token. For example, policy 825 can specify what level of access is to be granted to an account, based on the claims included in the security token. (In other words, policy 825 can specify the level of access criteria described above with reference to FIG. 6.)

After the query has been received and the information that determines the response identified, response generator 830 can generate the response, which can be transmitted to the requester via transmitter 835.

Although the queries endpoint 805 can receive might inquire about past behavior or potential future behavior of relying party 130, a person skilled in the art will recognize that the response to the query does not guarantee the behavior of relying party 130 when it actually receives a security token. This lack of guarantee applies even if the security token that is later sent exactly matches a previously sent security token, or if the security token includes exactly the information relying party 130 indicates is needed. The reason a response to a query provides no guarantee is simple: data can change, both within the security token and within the policies used by relying party 130 in processing the security token.

For example, consider the situation where the client queries endpoint 805 about how relying party 130 might respond given a security token: this security token is identified to endpoint 805 by some identifier. Relying party 130 can only respond with how it behaved the last time it received the identified security token. But if the information managed by an identity provider has changed since the last time a security token was generated using that information, the resulting security token will be different. Because relying party 130 cannot guarantee what will happen if the underlying data changes, endpoint 805 can only indicate what has happened previously.

Alternatively, consider the situation where the client sends a security token to endpoint 805 and inquires about how relying party 130 would treat the security token. Relying party 130 can indicate how the security token would be processed at the time of the query. But if the policies of relying party 130 change between the time the response to the query is sent and when the client submits the security token for identification purposes, relying party 130 might process the security token differently when it is offered for identification purposes.

Similarly, consider what can happen if the query inquires from endpoint 805 about what alternative levels of access are available for an account on relying party 130, and what claims would need to be provided to receive that alternative level of access. Endpoint 805 can indicate that a greater level of access could be granted if a biometric is included with the security token. But if policy 825 changes between the time endpoint 805 responds to the query and when the security token is actually received, it might be that the inclusion of the biometric claim is now insufficient to receive the alternative level of access. Thus, even a response indicating what kind of security token would be needed in the future is not a guarantee that that security token would actually result in receiving that alternative level of access.

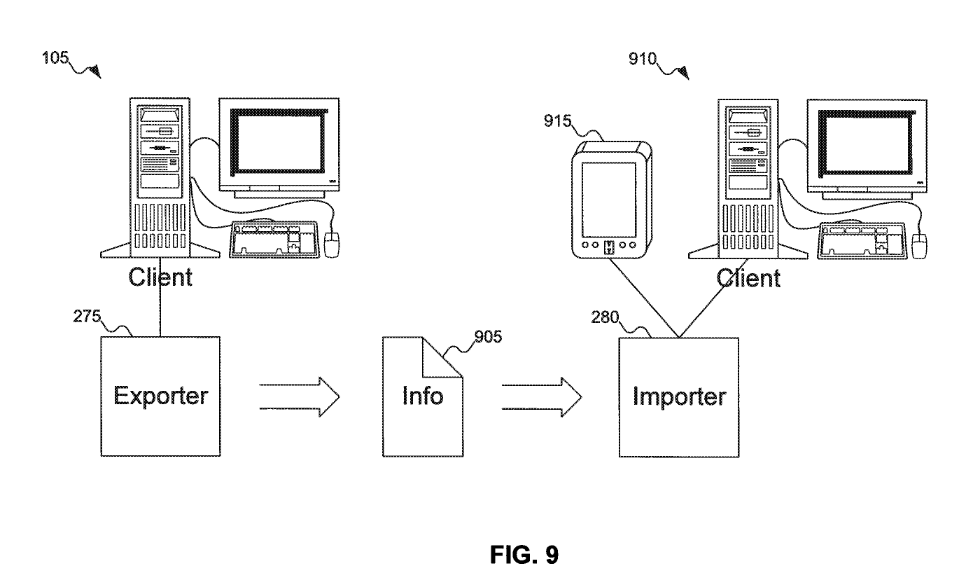

FIG. 9 shows the client of FIGS. 2A-2B and another client synchronizing federation point information and information cards. As discussed above with reference to FIG. 2B, synchronization of federation points and information cards enables a user to use this information from multiple machines, rather than being limited to a single machine storing the federation point information and information cards. FIG. 9 shows client 105 using exporter 275 to export information 905, which includes both information about the federation points on client 105 (or potentially only some of the federation points on client 105, depending on what information the user chooses to export), and about information cards on client 105. This information can then be imported into another client, such as client 910 or PDA 915 (among other possibilities of devices that can import such information) using importer 280. (A person skilled in the art will recognize that while FIG. 9 shows two potential importing clients 910 and 915 and only one importer 280, each receiving device often has its own importer 280.)

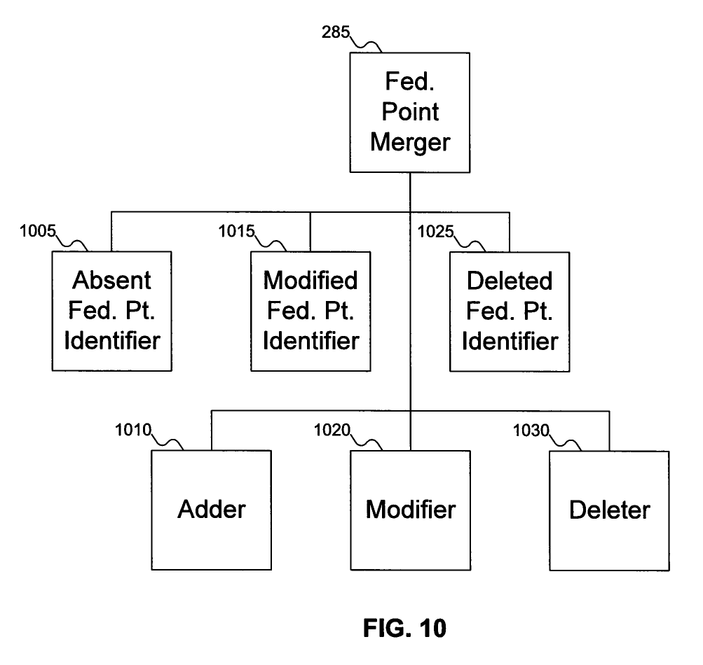

FIG. 10 shows the details about the federation point merger of FIG. 2B. As discussed above with reference to FIG. 2B, federation point merger 285 merges imported federation point information into the client's stored data. To accomplish this, federation point merger 285 can include absent federation point identifier 1005 and adder 1010: absent federation point identifier 1005 can identify a federation point in the imported data that is absent on the client machine, and adder 1010 can add the absent federation point to the client. Federation point merger 285 can also include modified federation point identifier 1015 and modifier 1020: modified federation point identifier can identify a federation point resident on both clients, but storing different data, and modifier 1020 can modify the federation point on the importing client to match the federation point exported from the other client. Finally, federation point merger 285 can include deleted federation point identifier 1025 and deleter 1030: deleted federation point identifier can identify a federation point that is resident on the importing client but that does not exist in the imported federation point information, and deleter 1030 can delete the identified federation point from the importing client.

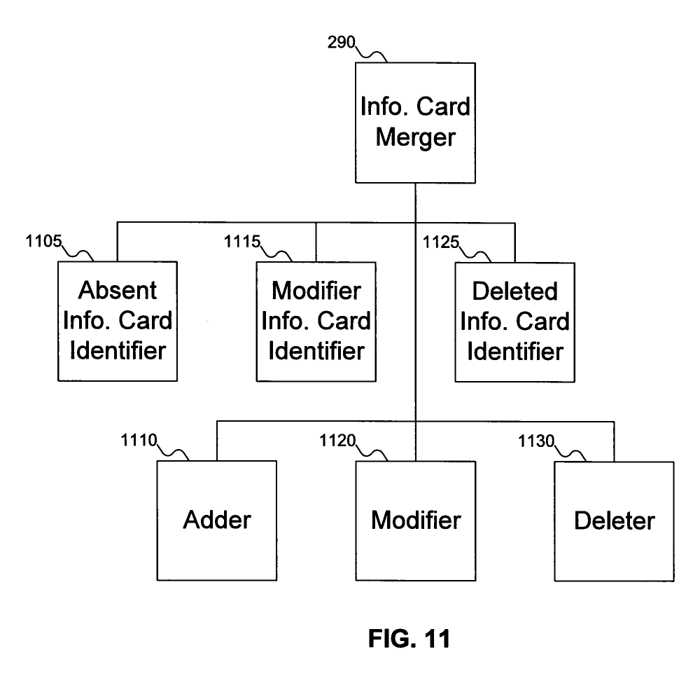

FIG. 11 shows details about the information card merger of FIG. 2B. Similar to federation point merger 285 of FIG. 10, information card merger 290 merges imported information cards into the client's stored data. To accomplish this, information card merger 290 can include absent information card identifier 1105 and adder 1110: absent information card identifier 1105 can identify an information card in the imported data that is absent on the client machine, and adder 1110 can add the absent information card to the client. Information card merger 290 can also include modified information card identifier 1115 and modifier 1120: modified information card identifier can identify an information card resident on both clients, but storing different data, and modifier 1120 can modify the information card on the importing client to match the information card exported from the other client. Finally, information card merger 290 can include deleted information card identifier 1125 and deleter 1130: deleted information card identifier can identify an information card that is resident on the importing client but that does not exist in the imported information card information, and deleter 1130 can delete the identified information card from the importing client.

While FIGS. 10 and 11 suggest that federation point merger 285 and information card merger 290 are separate elements, a person skilled in the art will recognize that this is not necessarily the case. For example, as discussed above with reference to FIG. 2A, federation point information can be stored as metadata to the information cards on the client. In that situation, federation point merger 285 is implicitly a part of information card merger 290, and might not be a separate element.

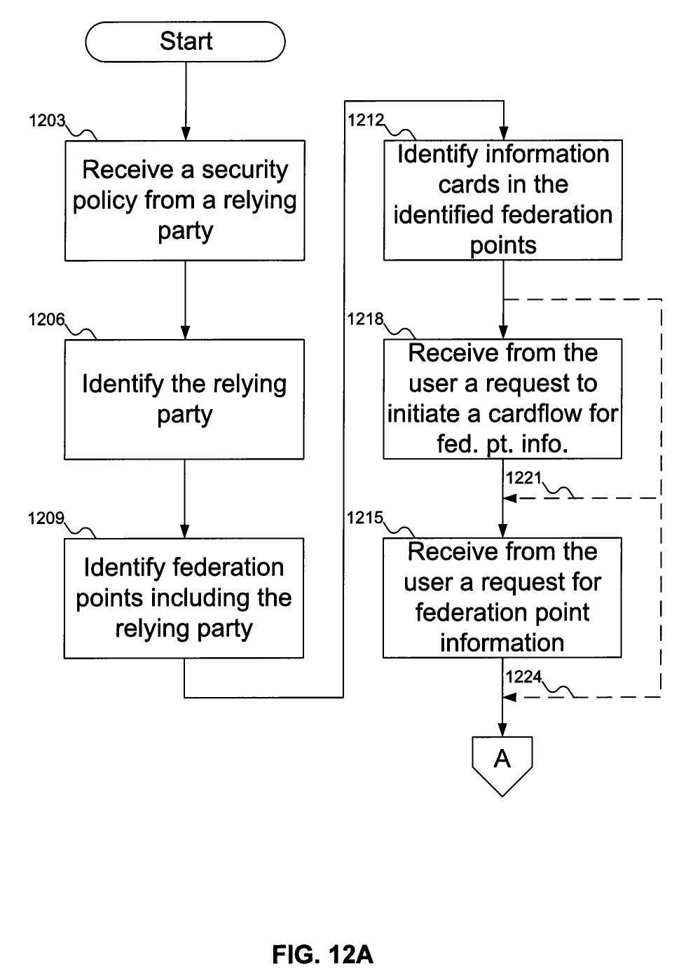

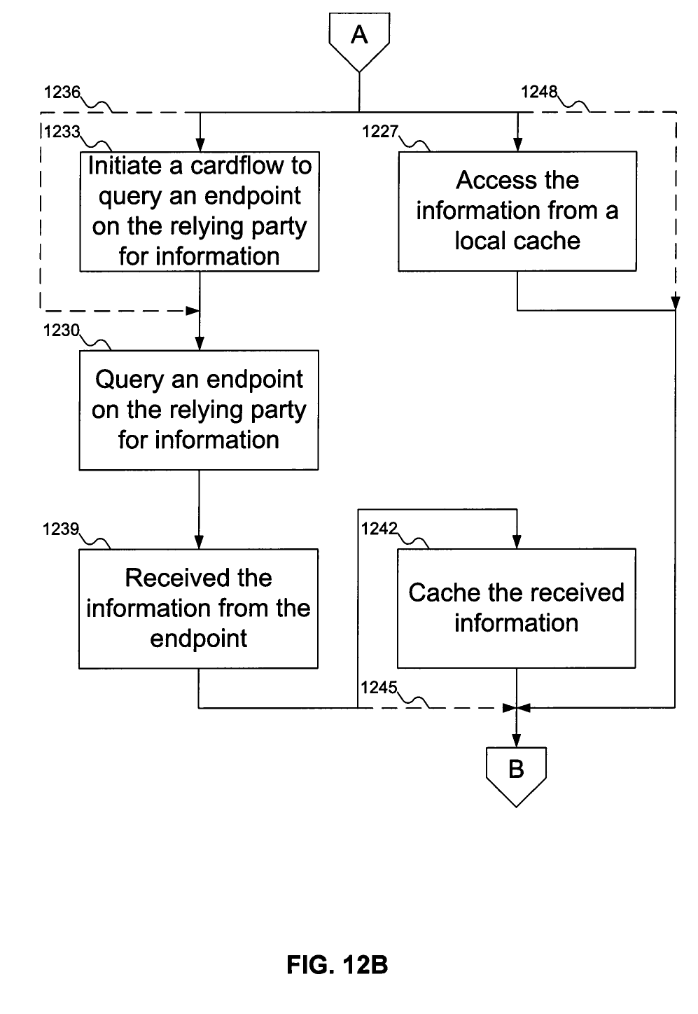

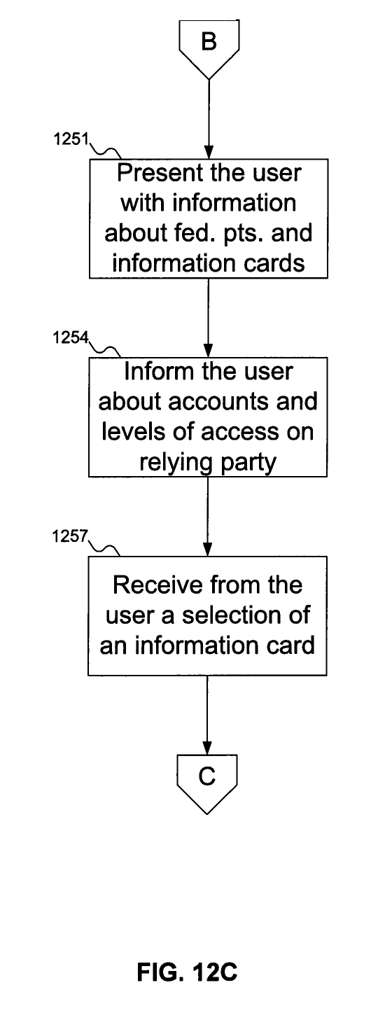

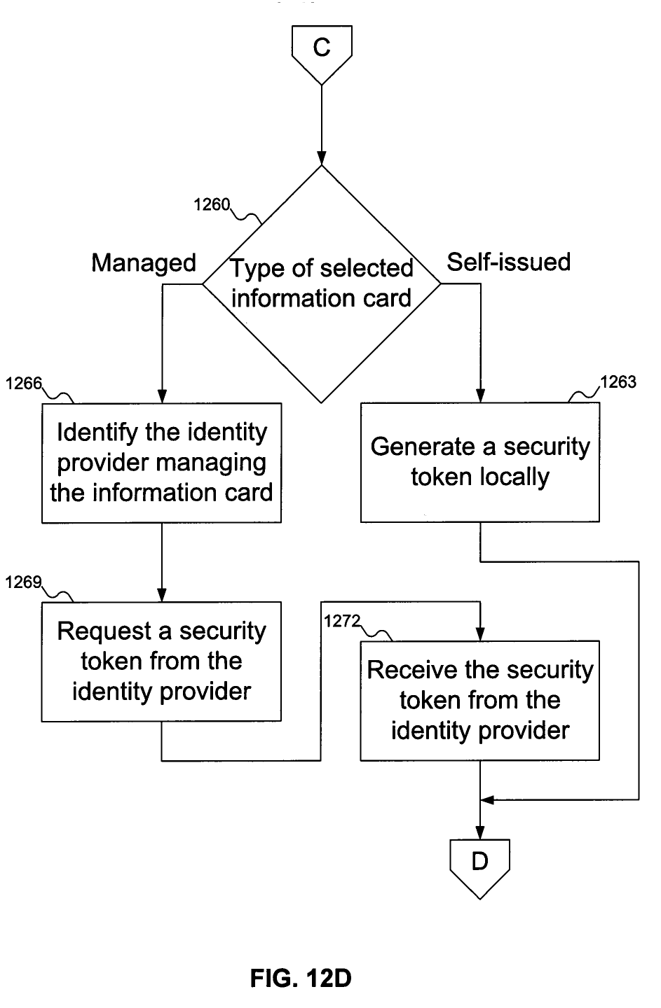

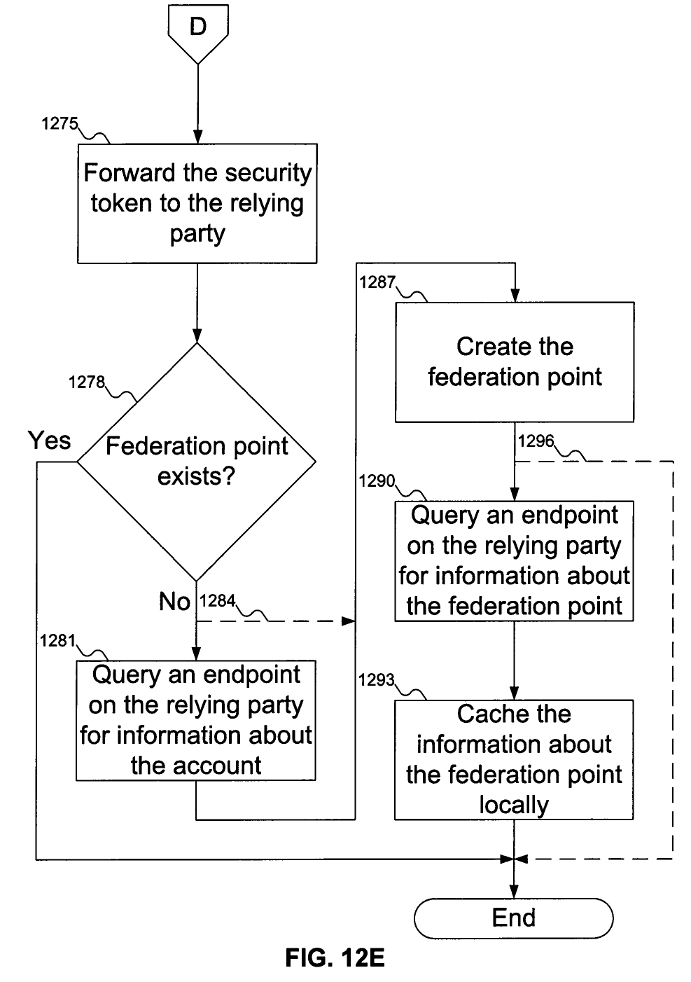

FIGS. 12A-12E show a flowchart of a procedure for the client of FIGS. 2A-2B to perform a transaction with a relying party using federation point information. In FIG. 12A, at block 1203, the client receives a security policy from a relying party. At block 1206, the client identifies the relying party. At block 1209, the client identifies federation points that include the relying party. At block 1212, the client identifies information cards that are included in the identified federation points. This can include requesting information from identity providers that are responsible for managing the identified information cards, so that the card selector can later present the user with the values that would be supplied to the relying party in the various claims: this information can be requested in the form of a security token for use by the client. At 1215 receives from the user a request for federation point information; this request can be embodied in a request to initiate a cardflow pertaining to federation points, as shown in block 1218. Block 1218 and block 1215 are both optional, as shown by dashed arrows 1221 and 1224: the user can skip requesting the cardflow, or requesting the information about the federation point information (that is, the client can omit presenting this information to the user, or the client can automatically display this information, without the user explicitly requesting it).

In FIG. 12B, the client can access information about how the relying party might respond to a particular security token generated using various information cards. At block 1227, the client can access information about how the relying party might respond to a security token from a local cache.

Alternatively, at block 1230, the client can query an endpoint on the relying party for the information. This query can be accomplished by initiating a cardflow, as shown in block 1233. Initiating the cardflow is optional, as shown by dashed arrow 1236. At block 1239, the client then receives the information from the endpoint on the relying party, and at block 1242 the client caches this information. Caching the information is optional, as shown by dashed line 1245. Alternatively, the client can skip accessing such information entirely, as shown by dashed line 1248.

At block 1251 (FIG. 12C), the client presents the user with information about the federation points and information cards. At block 1254, the client informs the user about accounts on the relying party, and the levels of access available for those accounts. At block 1257, the client receives from the user a selected information card, to use in generating the security token.

At block 1260 (FIG. 12D), the client identifies the type of the information card. If the information card is self-issued, then at block 1263 the client generates the security token using a local security token generator. If the information card is managed, then at block 1266 the client identifies the identity provider managing the information card. At block 1269, the client requests a security token from the identity provider, and at block 1272 the client receives from the identity provider the security token.

At block 1275 (FIG. 12E), the client forwards the security token (however generated) to the relying party. At block 1278, the client determines if a federation point (identifying the relying party, the account to which the user gains access, and the selected information card) exists. If not, then at block 1281 the client queries an endpoint on the relying party for information about the account on the relying party (this can be useful if the endpoint can provide information that the client does not already have about the federation point). Block 1281 is optional, as shown by dashed arrow 1284. At block 1287, the client creates the federation point, identifying in the federation point the account on the relying party and the information card. At block 1290, the client queries an endpoint on the relying party for information about the federation point, to store for future potential uses of the information card, and at block 1293 the client caches this information locally. Blocks 1290 and 1293 are optional, as shown by dashed line 1296.

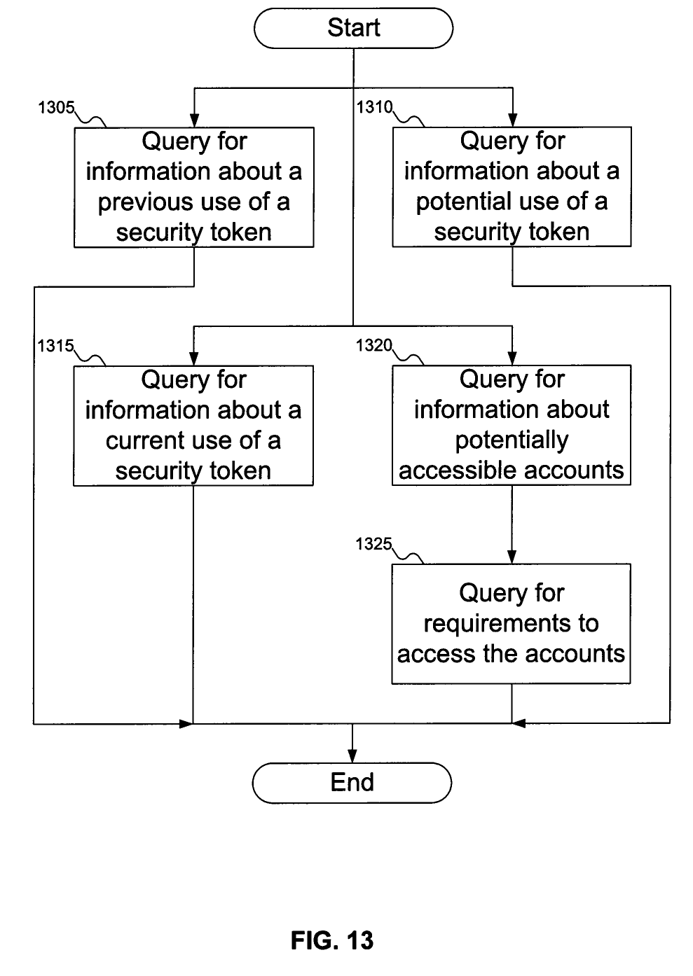

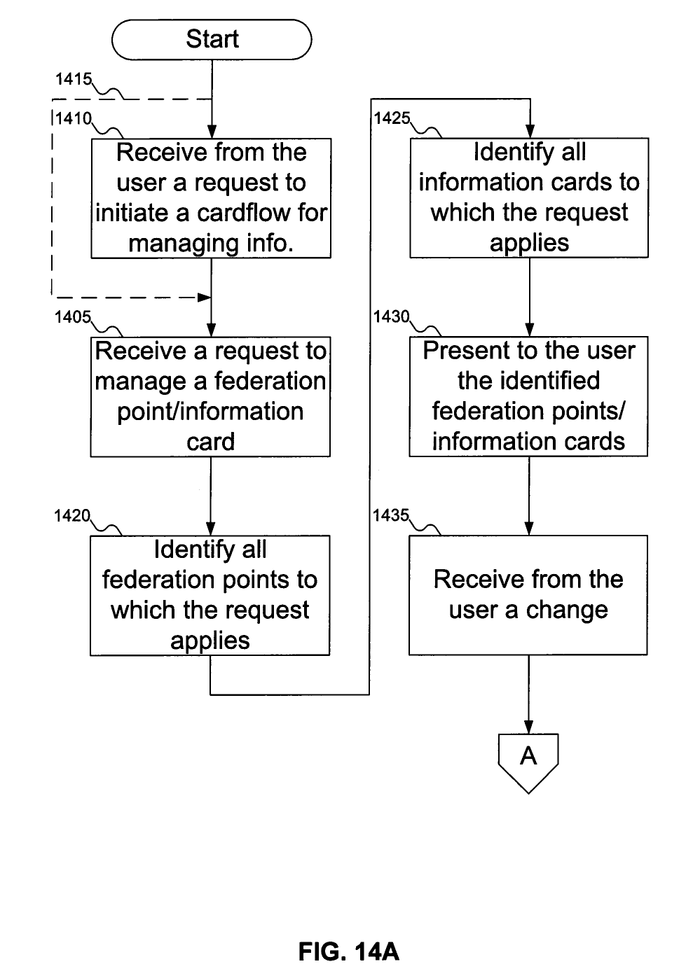

FIG. 13 shows a flowchart of a procedure for the client of FIGS. 2A-2B to query an endpoint on the relying party for information about an account on the relying party. Among the different information a client can query an endpoint about are: information about a previous use of a security token (block 1305); information about a potential use of a security token (block 1310); information about a current use of a security token (1315); and information about accounts (or different levels of access associated with accounts) to which the user might potentially gain access (block 1320). If the client is querying for information about accounts (or different levels of access associated with accounts) to which the user might potentially gain access (block 1320), the client can also query for information about the requirements to access those accounts (block 1325): for example, claims that would need to be in the security token for the user to gain that level of access.

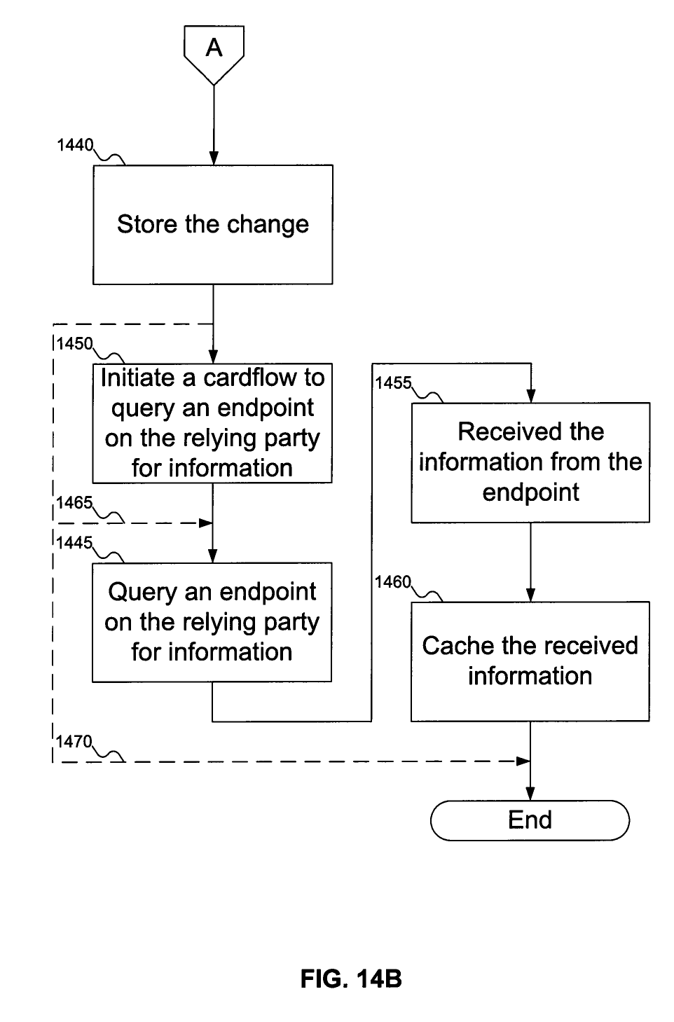

FIGS. 14A-14B show a flowchart of a procedure for the client of FIGS. 2A-2B to manage federation points and information cards. In FIG. 14A, at block 1405, the client receives a request to manage a federation point and/or an information card. This request can be embodied in a request to initiate a cardflow pertaining to managing federation points and/or information cards, as shown in block 1410. Block 1410 is optional, as shown by dashed arrow 1415: the user can skip requesting the cardflow. At block 1420, the client identifies all federation points to which the request applies. At block 1425, the client identifies all information cards to which the request applies. At block 1430, the client presents to the user the identified federation points and/or information cards. At block 1435, the client receives from the user a requested change.

At block 1440 (FIG. 14B), the client stores the change (that is, the client implements the requested change). At block 1445, the client queries an endpoint on the relying party for information (for example, how the relying party might respond to a security token generated from a particular information card). This request can be embodied in a request to initiate a cardflow pertaining to managing federation points and/or information cards, as shown in block 1410. This query can be accomplished by initiating a cardflow, as shown in block 1450. At block 1455, the client receives from the endpoint the requested information, and at block 1460 the client caches the received information. Block 1450 and blocks 1445, 1455, and 1460 are optional, as shown by dashed arrows 1465 and 1470.

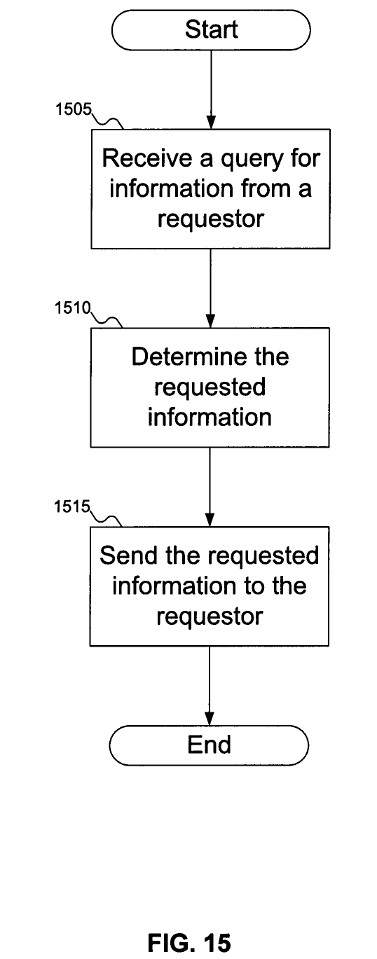

FIG. 15 shows a flowchart of a procedure for the relying party of FIG. 1 to respond to a query for information about an account on the relying party. In FIG. 15, at block 1505, the endpoint on the relying party receives a query for information from a requestor (typically a client machine being used by a user). At block 1510, the endpoint determines the requested information, and at block 1515 the endpoint sends the requested information to the requestor.

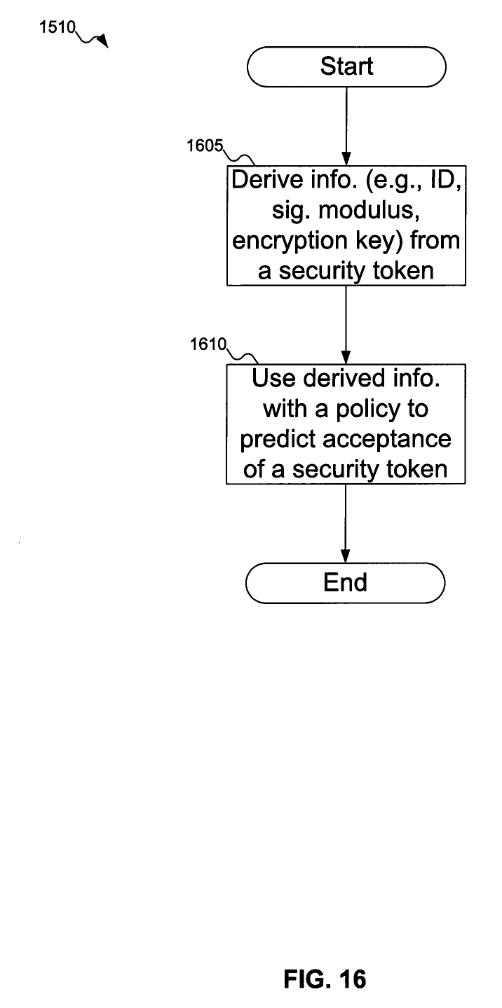

FIG. 16 shows a flowchart of a procedure for the relying party to use information derived from an information card to respond to a query for information about an account on the relying party. In FIG. 16, at block 1605, the endpoint can derive information from a security token. This derived information can include an identifier of the security token, a signature modulus, an encryption key, or a combination of these components, among other possibilities. At block 1610, the endpoint uses the derived information in conjunction with a policy on the relying party to predict the acceptance of the security token.

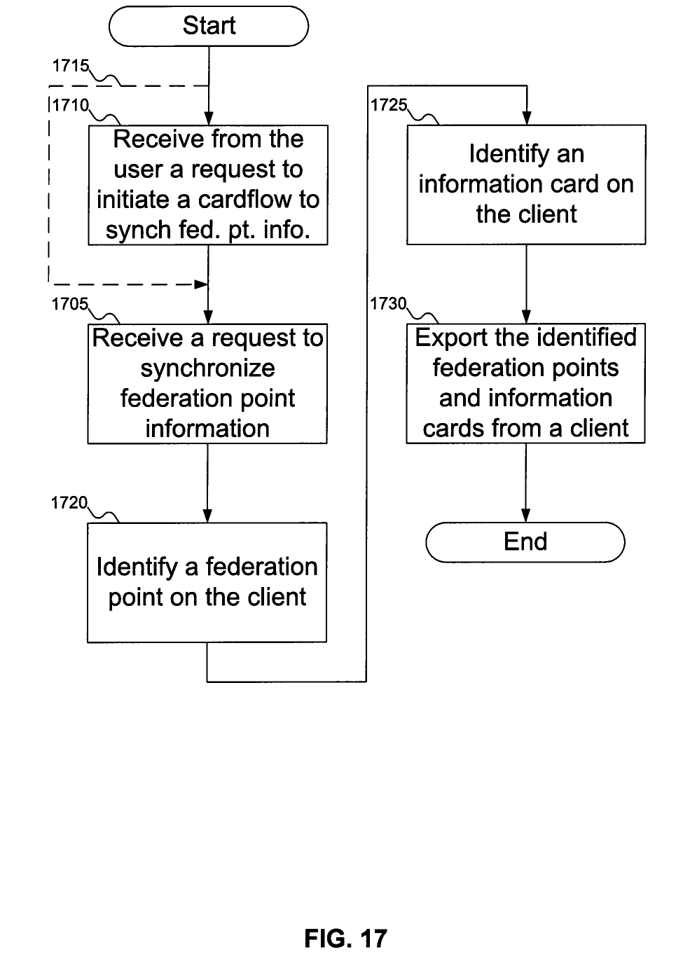

FIG. 17 shows a flowchart of a procedure for the client of FIGS. 2A-2B to export information about federation points and/or information cards to another client, as part of a synchronization process. At block 1705, the client receives a request to synchronize federation point information; this request can be embodied in a request to initiate a cardflow to synchronize federation point information, as shown in block 1710. Block 1710 is optional, as shown by dashed line 1715. At block 1720, the client identifies a federation point that is to be synchronized. This can entail identifying every federation point on the client, or just specific federation points that the user wants to synchronize. At block 1725, the client identifies an information card that is to be synchronized. As with the federation points, this can entail identifying every information card on the client, or just specific information cards that the user wants to synchronize. At block 1730, the client exports the identified federation points and information cards.

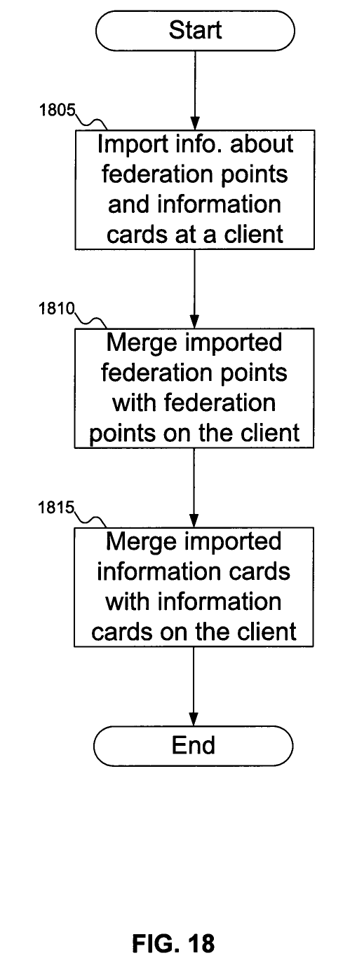

FIG. 18 shows a flowchart of a procedure for the client of FIGS. 2A-2B to import information about federation points and/or information cards from another client, as part of a synchronization process. At block 1805, the client imports information about federation points and information cards. At block 1810, the client merges the imported federation points, and at block 1815, the client merges the imported information cards.

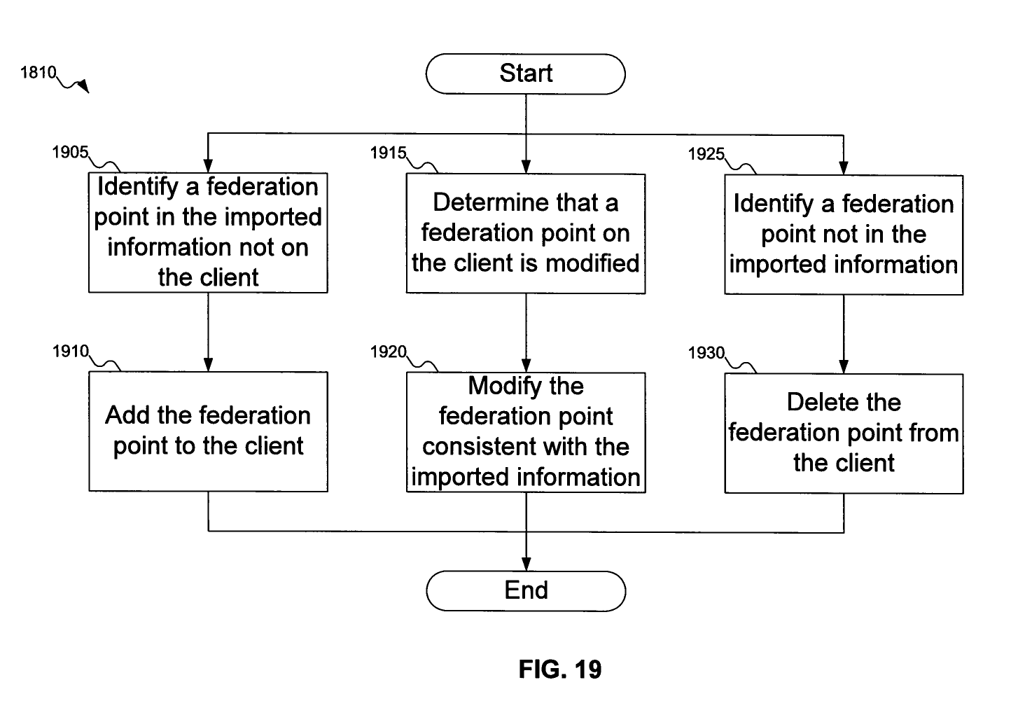

FIG. 19 shows a flowchart of a procedure for the client of FIGS. 2A-2B to synchronize information about federation points imported from another client. At block 1905, the client identifies a federation point in the imported information that is not resident on the client; at block 1910, the client then adds the federation point. At block 1915, the client determines that a federation point on the client is modified; at block 1920, the client modifies the federation point to be consistent with the imported federation point. At block 1925, the client identifies a federation point resident on the client that is not in the imported information; at block 1930, the client deletes the federation point.

While FIG. 19 shows blocks 1905, 1910, 1915, 1920, 1925, and 1930 being performed once, a person skilled in the art will recognize that there are many variations on how federation point information is merged, and that FIG. 19 is merely exemplary. There might be many federation points to add, modify, and/or delete, in which case the appropriate blocks of FIG. 19 can be repeated as necessary to complete the merge operation.

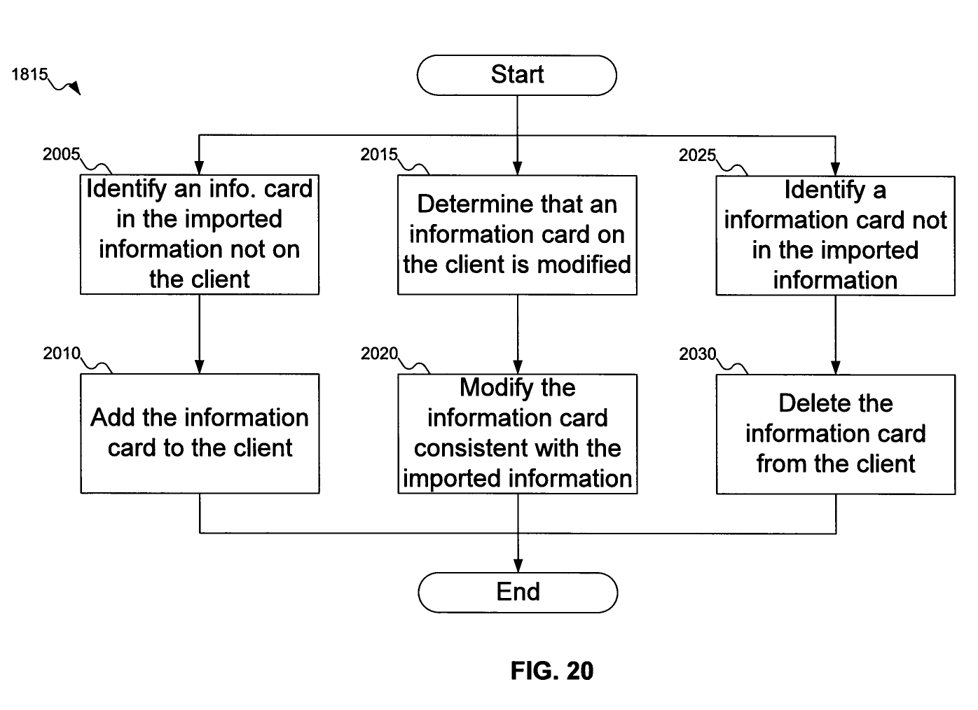

As with the federation points of FIG. 19, information cards can be merged from imported information. FIG. 20 shows a flowchart of a procedure for the client of FIGS. 2A-2B to synchronize information about information cards imported from another client. At block 2005, the client identifies an information card in the imported information that is not resident on the client; at block 2010, the client then adds the information card. At block 2015, the client determines that an information card on the client is modified; at block 2020, the client modifies the information card to be consistent with the imported information card. At block 2025, the client identifies an information card resident on the client that is not in the imported information; at block 2030, the client deletes the information card.

While FIG. 20 shows blocks 2005, 2010, 2015, 2020, 2025, and 2030 being performed once, a person skilled in the art will recognize that there are many variations on how information card information is merged, and that FIG. 20 is merely exemplary. There might be many information cards to add, modify, and/or delete, in which case the appropriate blocks of FIG. 20 can be repeated as necessary to complete the merge operation.

The above discussion defines a federation point as the combination of an identifier of an account on the relying party and an identifier of an information card on a client. A federation point enables a user to learn how a relying party identifies the user, and how that identification can be used. For example, the act of “federation” occurs whenever an information card is presented to a relying party (or more specifically, when a security token, generated using the selected information card, is presented to a relying party). At the time the relying party receives a security token, the relying party determines who the user is to that relying party and what privileges and capabilities are granted to that user. (Because a user might have multiple different identities, represented by different information cards, the relying party is not determining the user's actual identity, but rather who the relying party perceives the user to be.) The relying party has complete discretion and control in deciding which factors from the security token are used to determine who the user is and what privileges and capabilities are granted to that user. But these factors are limited to information that is received with the security token: for example, the claims requested by the relying party in the security policy (required, optional, or otherwise-categorized claims, and\or their values), and other security token metadata such as the card issuer, expiration dates, etc.

If the user is interested in information that goes beyond how the relying party identifies the user, a federation point might not provide sufficient information. For example, the services or privileges the relying party offers might be completely independent of the account to which a user is granted access. In fact, if the relying party does not maintain static information about user accounts, a federation point might not provide the user with any information about how the relying party identifies the user. For example, if the relying party defines the account dynamically at the time the user requests access and destroys any information about the account once access is complete, the user is not given access to any single “defined” account, and a federation point would provide no benefit. For the user to access information about such services, privileges, features accessible on the relying party, and other functionalities offered by the relying party, the user can instead use a level of service descriptor. In addition, level of service descriptors can be used to provide relying party-defined information that is not defined by any generally-accepted standard. A level of service descriptor is a mechanism that operates similarly to a federation point, but provides the user with information about the nature and level of the service a relying party provides, including among other possibilities the privileges, features, capabilities, temporal constraints, and other relying party-defined information.

Note that level of service descriptor does not have to include the identification of a particular account on the relying party. Further, some information about the level of service descriptor can be considered optional. For example, as discussed above, the relying party might not have a user account defined for the user—the relying party might dynamically create the user account when presented with the security token, and “close” the account when the transaction is complete. In such an embodiment, the relying party would have no need to create or track users of the relying party's services with formal accounts, and might use the claims provided in the security token to identify the user. In fact, the relying party might have no need to identify the presenter of the security token in the form of a “user” at all. The relying party might only use the security token to specify the privileges or capabilities granted to the party presenting the security token. Similarly, the relying party might not identify specific privileges or capabilities for a user, but use the security token to identify a specific account being used. But regardless of how the relying party uses the security token, any relying party can provide level of service descriptor information insofar as it applies to their service. Other examples of information that can be considered optional in a level of service descriptor can include privileges, capabilities, quality of service, and temporal constraints, as well as other potentially relying party-specific level of service information.

In one embodiment of the invention, a level of service descriptor can request information about a federation point. In such an embodiment, a person might consider a level of service descriptor to be a generalization of a federation point. But because a level of service descriptor in general provides a different scope of functionality than a federation point, and because the inclusion of federation point information in a level of service descriptor is optional, it is simplistic to view a level of service descriptor to be a generalization of a federation point: in general, federation points and level of service descriptor have little in common. The information created in a level of service descriptor may be created based on any claims provided in a security token, since those claims may be used by the relying party to provide different levels of service. In contrast, federation points focus on the claims in the security token used by the relying party to identify the user; any claims not relevant to the user's identification are typically not part of the federation point.

There are numerous situations in which tracking federation point or level of service descriptor information is useful. The embodiments of the invention described above illustrate some such situations. Other situations in which tracking federation point or level of service descriptor information can be useful include embodiments where the user is expected to choose an information card, either through the card selector or through some other means, such as those described in co-pending U.S. patent application Ser. No. 12/243,619, titled “SYSTEM AND METHOD FOR APPLICATION-INTEGRATED INFORMATION CARD SELECTION”, filed Oct. 1, 2008, which is herein incorporated by reference for all purposes. For example, when a user is interacting with an application that requests a security token (be it an application running on the user's computer or a relying party accessed via a browser), the selector daemon can poll the application for the current state of the federation point or level of service descriptor. Then, when the user is requested to select an information card to use in generating a security token, the user can be presented with the most current state of the federation point or level of service descriptor. As discussed above, the cached information about a past state of the federation point or level of service descriptor is not considered to be a guarantee of what might happen when the security token is sent to the application in the current use. For example, the application might have its security policy or the factors it uses to identify the user's accounts, privileges, and capabilities.

To gather this federation point or level of service descriptor information (regardless of when the federation point information is requested or the process by which it is gathered), a relying party defines and implements an endpoint. This endpoint would receive the same security token that would be presented to the relying party after an information card was selected by the user. But the endpoint would not use the security token to authenticate the user: the endpoint uses the security token to estimate what might happen if that security token were presented to the relying party after the user's selection of an information card. This allows the relying party to make the same computations it would make if it were actually being presented with the specified token for authentication. In the most straightforward embodiment of the invention, the card selector is invoked, shows the information cards that satisfy the relying party's security policy, requests the federation point or level of service descriptor information for each such information card, and displays the federation point or level of service descriptor information with each card to enable the user to make an informed selection. This display of the federation point or level of service descriptor information can also include sorting the information cards based on the federation point information, or providing the user with some cues about the information cards and their federation point or level of service descriptor information, as described in co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, and co-pending U.S. patent application Ser. No. 12/112,772, titled “DYNAMIC INFORMATION CARD RENDERING”, filed Apr. 30, 2008, which are herein incorporated by reference for all purposes.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface, and input/output interface ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a client (105);
a receiver (210) on the client (105) to receive a request (705, 710, 715) from a user to manage at least one of a federation point (230, 525, 505, 510, 515) and an information card (220, 530);
a data store (225) on the client (105), the data store (225) capable of storing federation points (230, 525, 505, 510, 515), each federation point (230, 525, 505, 510, 515) including an identifier (520) of an account (605, 610, 615, 620) on a relying party (130) and an identifier (530) of an information card (220);
a data store accessor (240) on the client (105) to access said federation points (230, 525, 505, 510, 515) stored in the data store (225);
an identifier (265) on the client (105) to identify federation points (230, 525, 505, 510, 515) in the data store (225) and to identify information cards (220, 530) in the card selector (205) to which said request is applicable; and
a card selector (205) on the client (105) to present information about said federation points (230, 525, 505, 510, 515) in the data store (225) to said user and to receive from said user a change (720, 725, 730) to at least one of said identified federation points (230, 525, 505, 510, 515) and said identified information cards (220, 530).

2. An apparatus according to claim 1, further comprising a data store modifier (270) on the client (105) to modify the data store (225) responsive to said received change.

3. An apparatus according to claim 1, wherein said request (705, 710, 715) includes a request (705) to manage all federation points (230, 525, 505, 510, 515) including said relying party (130).

4. An apparatus according to claim 1, wherein said request (705, 710, 715) includes a request (710) to manage all information cards (220, 530) included in a selected federation point (230, 525, 505, 510, 515).

5. An apparatus according to claim 1, wherein said request (705, 710, 715) includes a request (715) to manage all federation points (230, 525, 505, 510, 515) including a selected information card (220, 530).

6. An apparatus according to claim 1, wherein:
the apparatus further comprises an query mechanism (250) on the client (105) to query an endpoint (805) on a relying party (130) for information (815) about an account (605, 610, 615, 620) included in a given federation point (230, 525, 505, 510, 515) including a given information card (220, 530); and
the receiver (210) is operative to receive said information (815) about said account (605, 610, 615, 620) included in said given federation point (230, 525, 505, 510, 515) including said given information card (220, 530) from said endpoint (805).

7. A method, comprising:
receiving (1405) a request (705, 710, 715) to manage at least one of a federation point (230, 525, 505, 510, 515) and an information card (220, 530);
identifying (1420, 1425) all federation points (230, 525, 505, 510, 515) and information cards (220, 530) to which the request is applicable;
presenting (1430) to a user the identified federation points (230, 525, 505, 510, 515) and the identified information cards (220, 530);
receiving (1435) from the user a change (720, 725, 730) to at least one of the identified federation points (230, 525, 505, 510, 515) or one of the identified information cards (220, 530); and
storing (1440) the received change (720, 725, 730).

8. A method according to claim 7, wherein receiving (1405) a request (705, 710, 715) to manage at least one of a federation point (230, 525, 505, 510, 515) and an information card (220, 530) includes receiving (1405) a request (705) to manage all federation points (230, 525, 505, 510, 515) including the relying party (130).

9. A method according to claim 7, wherein receiving (1405) a request (705, 710, 715) to manage at least one of a federation point (230, 525, 505, 510, 515) and an information card (220, 530) includes receiving (1405) a request (710) to manage all information cards (220, 530) included in federation points (230, 525, 505, 510, 515) including the identifier (520) of the account (605, 610, 615, 620) on the relying party (130).

10. A method according to claim 7, wherein receiving (1405) a request (705, 710, 715) to manage at least one of a federation point (230, 525, 505, 510, 515) and an information card (220, 530) includes receiving (1405) a request (715) to manage all federation points (230, 525, 505, 510, 515) including a selected information card (220, 530).

11. A method according to claim 7, further comprising querying (1445) an endpoint (805) of a relying party (130) regarding an account (605, 610, 615, 620) included in a given federation point (230, 525, 505, 510, 515) including a given information card (220, 530).

12. A system, comprising:
a client (105, 910);
a data store (225) on the client (105, 910), the data store (225) capable of storing federation points (230, 525, 505, 510, 515), each federation point (230, 525, 505, 510, 515) including an identifier (520) of an account (605, 610, 615, 620) of an account on a relying party (130) and an identifier (530) of an information card (220);
a set of information cards (220, 530) on the client (105, 910);
a data store accessor (240) on the client (105, 910) to identify at least one federation point (230, 525, 505, 510, 515) in the data store (225); and
an exporter (275) on the client (105, 910) to export information (905) about said at least one federation point (230, 525, 505, 510, 515) and information (905) about said at least one information card (220, 530).

13. A system according to claim 12, further comprising:
a workflow manager on the client (105, 910) to execute a cardflow;
a cardflow store on the client (105, 910), the cardflow store capable of storing said cardflow; and
the receiver (210) on the client (105, 910) is operative to receive a request by a user to initiate said cardflow to synchronize said at least one federation point (230, 525, 505, 510, 515).

14. A method, comprising:
receiving (1705) a request to synchronize federation point (230, 525, 505, 510, 515) information on a first client (105, 910) with a second client (105, 910);
identifying (1720) at least one federation point (230, 525, 505, 510, 515) on the first client (105, 910);
identifying (1725) at least one information card (220, 530) included in the identified federation point (230, 525, 505, 510, 515) on the first client (105, 910); and
exporting (1730) from the first client (105, 910) information (905) about the identified federation point (230, 525, 505, 510, 515) and information (905) about the identified information card (220, 530) included in the identified federation point (230, 525, 505, 510, 515).

15. A method according to claim 14, wherein receiving (1705) the request to synchronize federation point (230, 525, 505, 510, 515) information comprises receiving (1710) a request to initiate a cardflow on the first client (105, 910) to synchronize the federation point (230, 525, 505, 510, 515) information on the first client (105, 910) with the second client (105, 910).

16. A system, comprising:
a client (105, 910);
a data store (225) on the client (105, 910), the data store (225) capable of storing federation points (230, 525, 505, 510, 515), each federation point (230, 525, 505, 510, 515) including an identifier (520) of an account (605, 610, 615, 620) on a relying party (130) and an identifier (530) of an information card (220);
a set of information cards (220, 530) on the client (105, 910);
an importer (280) to receive information (905) about at least one federation point (230, 525, 505, 510, 515) and information (905) about at least one information card (220, 530);
a federation point merger (285) to merge said information (905) about said at least one federation point (230, 525, 505, 510, 515) into the data store (225); and
an information card merger (290) to merge said information (905) about said at least one information card (220, 530) into the set of information cards (220, 530).

17. A system according to claim 16, wherein the federation point merger (285) includes:
an absent federation point identifier (1005) to identify an absent federation point (230, 525, 505, 510, 515) in said information (905) about said at least one federation point (230, 525, 505, 510, 515) that is not in the data store (225); and
an adder (1010) to add said absent federation point (230, 525, 505, 510, 515) to the data store (225).

18. A system according to claim 16, wherein the federation point merger (285) includes:
a modified federation point identifier (1015) to identify a modified federation point (230, 525, 505, 510, 515) in said information (905) about said at least one federation point (230, 525, 505, 510, 515) that exists in the data store (225); and
a modifier (1020) to modify said federation point (230, 525, 505, 510, 515) in the data store (225) to be consistent with said modified federation point (230, 525, 505, 510, 515).

19. A system according to claim 16, wherein the federation point merger (285) includes:
a deleted federation point identifier (1025) to identify a deleted federation point (230, 525, 505, 510, 515) in the data store (225) that is not in said information (905) about said at least one federation point (230, 525, 505, 510, 515); and
a deleter (1030) to delete said deleted federation point (230, 525, 505, 510, 515) from the data store (225).

20. A system according to claim 16, wherein the information card merger (290) includes:
an absent information card identifier (1105) to identify an absent information card (220, 530) in said information (905) about said at least one information card (220, 530) that is not in the set of information cards (220, 530; and
an adder (1110) to add said absent information card (220, 530) to the set of information cards (220, 530).

21. A system according to claim 16, wherein the information card merger (290) includes:
a modified information card identifier (1115) to identify a modified information card (220, 530) in said information (905) about said at least one information card (220, 530) that exists in the set of information cards (220, 530); and
a modifier (1120) to modify said information card (220, 530) in the set of information cards (220, 530) to be consistent with said modified information card (220, 530).

22. A system according to claim 21, wherein the modifier (1120) is operative to modify said information card (220, 530) in the set of information cards (220, 530) to be included in a first federation point (230, 525, 505, 510, 515) instead of a second federation point (230, 525, 505, 510, 515).

23. A system according to claim 16, wherein the information card merger (290) includes:
a deleted information card identifier (1125) to identify a deleted information card (220, 530) in the set of information cards (220, 530) that is not in said information (905) about said at least one information card (220, 530); and
a deleter (1130) to delete said deleted information card (220, 530) from the set of information cards (220, 530).

24. A method, comprising:
importing (1805) into a client (105, 910) information (905) about at least one federation point (230, 525, 505, 510, 515) and information (905) about at least one information card (220, 530) included in the federation point (230, 525, 505, 510, 515);
merging (1810) the information (905) about the at least one federation point (230, 525, 505, 510, 515) with federation point (230, 525, 505, 510, 515) information on the client (105, 910); and
merging (1815) the information (905) about the at least one information card (220, 530) included in the federation point (230, 525, 505, 510, 515) with at least information card (220, 530) on the client (105, 910).

25. A method according to claim 24, wherein merging (1810) the information (905) about the at least one federation point (230, 525, 505, 510, 515) with federation point (230, 525, 505, 510, 515) information on the client (105, 910):
determining (1905) that the at least one federation point (230, 525, 505, 510, 515) does not exist in the federation point (230, 525, 505, 510, 515) information on the client (105, 910); and
adding (1910) the at least one federation point (230, 525, 505, 510, 515) to the federation point (230, 525, 505, 510, 515) information on the client (105, 910).

26. A method according to claim 24, wherein merging (1810) the information (905) about the at least one federation point (230, 525, 505, 510, 515) with federation point (230, 525, 505, 510, 515) information on the client (105, 910) includes:
determining (1915) that the at least one federation point (230, 525, 505, 510, 515) exists in the federation point (230, 525, 505, 510, 515) information on the client (105, 910); and
modifying (1920) the federation point (230, 525, 505, 510, 515) information on the client (105, 910) to be consistent with the information (905) about the at least one federation point (230, 525, 505, 510, 515).

27. A method according to claim 24, wherein merging (1810) the information (905) about the at least one federation point (230, 525, 505, 510, 515) with federation point (230, 525, 505, 510, 515) information on the client (105, 910) includes:
identifying (1925) a federation point (230, 525, 505, 510, 515) in the federation point (230, 525, 505, 510, 515) information on the client (105, 910) that is not included in the information (905) about the at least one federation point (230, 525, 505, 510, 515); and
deleting (1930) the identified federation point (230, 525, 505, 510, 515) from the federation point (230, 525, 505, 510, 515) information on the client (105, 910).

28. A method according to claim 24, wherein merging (1815) the information (905) about the at least one information card (220, 530) included in the federation point (230, 525, 505, 510, 515) with at least information card (220, 530) on the client (105, 910) includes:
determining (2005) that the at least one information card (220, 530) does not exist on the client (105, 910); and
adding (2010) the at least one information card (220, 530) to the client (105, 910).

29. A method according to claim 24, wherein merging (1815) the information (905) about the at least one information card (220, 530) included in the federation point (230, 525, 505, 510, 515) with at least information card (220, 530) on the client (105, 910) includes:
determining (2015) that the at least one information card (220, 530) exists on the client (105, 910); and
modifying (2020) the client (105, 910) so that the at least one information card (220, 530) on the client (105, 910) is consistent with the information (905) about the at least information card (220, 530).

30. A method according to claim 29, wherein modifying (2020) the client (105, 910) so that the at least one information card (220, 530) on the client (105, 910) is consistent with the information (905) about the at least information card (220, 530) includes modifying an information card (220, 530) on the client (105, 910) so that the information card (220, 530) on the client (105, 910) is included in the at least one federation point (230, 525, 505, 510, 515).

31. A method according to claim 24, wherein merging (1815) the information (905) about the at least one information card (220, 530) included in the federation point (230, 525, 505, 510, 515) with at least information card (220, 530) on the client (105, 910) includes:
identifying (2025) an information card (220, 530) on the client (105, 910) that is not included in the information (905) about the at least one information card (220, 530); and
deleting (2030) the identified information card (220, 530) from the client (105, 910).
